(19) United States
(12) Patent Application Publication
(10) Pub. No.: US 2024/0080866 A1
(43) Pub. Date: Mar. 7, 2024

(54) METHOD PERFORMED BY USER EQUIPMENT, AND USER EQUIPMENT

(71) Applicant: Sharp Kabushiki Kaisha, Sakai City, Osaka (JP)

(72) Inventors: Chao LUO, Shanghai (CN); Renmao LIU, Shanghai (CN); Yinan ZHAO, Shanghai (CN)

(21) Appl. No.: 18/271,510

(22) PCT Filed: Jan. 11, 2022
(86) PCT No.: PCT/CN2022/071264

§ 371 Date: Jul. 10, 2023

(30) Foreign Application Priority Data
Jan. 14, 2021 (CN) 202110051742.7

(51) Int. Cl. H04W 72/40; H04W 72/25; H04W 72/563

(52) U.S. Cl. CPC H04W 72/40; H04W 72/25; H04W 72/563

(57) ABSTRACT

Provided in the present invention are a method performed by user equipment and user equipment. The method performed by user equipment includes: receiving a coordination request in a first resource pool, determining a coordination resource set in a second resource pool, and transmitting, in a third resource pool, a coordination message as a response to the coordination request, wherein the coordination message includes an indication for the coordination resource set, and the first resource pool, the second resource pool, and the third resource pool are the same resource pool.

### TECHNICAL FIELD

The present invention relates to a method performed by user equipment, and user equipment.

### BACKGROUND

SL communication (e.g., when SL resource allocation mode 2 is configured) can support inter-UE coordination functions, e.g., coordination of resource (e.g., SL resources) allocation between two or more UEs. For the inter-UE coordination functions, problems such as definition, transmission, reception, etc., of inter-UE coordination messages need to be solved.

### PRIOR ART DOCUMENTS

### Non-Patent Documents

Non-Patent Document 1: RP-152293, New WI proposal: Support for V2V services based on LTE sidelink

Non-Patent Document 2: RP-170798, New WID on 3GPP V2X Phase 2

Non-Patent Document 3: RP-170855, New WID on New Radio Access Technology

Non-Patent Document 4: RP-190766, New WID on 5G V2X with NR sidelink

Non-Patent Document 5: RP-201385, WID revision: NR sidelink enhancement

### SUMMARY

In order to solve at least some of the above problems, provided in the present invention are a method performed by user equipment and user equipment. A priority of a coordination resource is indicated in an inter-UE coordination message, so that a plurality of UEs receiving the inter-UE coordination message may determine, according to a priority indicated when a resource corresponding to the coordination resource (e.g., a resource coinciding with the coordination resource) was allocated and/or reserved thereby, whether to drop the coordination resource, thereby alleviating the problem of resource conflict in a distributed resource reservation mechanism, and improving resource utilization efficiency.

According to the present invention, a method performed by user equipment is provided. The method is characterized by comprising: determining a coordination resource according to one or more detected SCIs; and adding each coordination resource to a coordination resource set; and transmitting an inter-UE coordination message comprising the coordination resource set. If it is detected that resources indicated in two or more SCIs respectively overlap with a reference resource n, the reference resource n is determined as a coordination resource. The reference resource n is a time-frequency resource numbered n among a plurality of time-frequency resources defined in a time window and a frequency range and having the same time domain and frequency domain sizes.

Preferably, in the inter-UE coordination message, a coordination resource priority is indicated for each of the coordination resources. The value of the coordination resource priority is equal to the smallest value among priority values respectively indicated by the two or more SCIs.

Furthermore, according to the present invention, a method performed by user equipment is provided. The method is characterized by comprising: receiving one or more inter-UE coordination messages, and performing one or more priority related operations. If a coordination resource indicated in the one or more inter-UE coordination messages overlaps with a reserved resource, and a priority value of the coordination resource is less than a priority value of the reserved resource, then the reserved resource is removed from a corresponding SL grant, and/or resource selection is performed for the reserved resource.

In addition, according to the present invention, provided is user equipment, comprising: a processor; and a memory, having instructions stored therein, wherein when run by the processor, the instructions perform the aforementioned method.

Thus, provided in the present invention is a method, in which a priority of a coordination resource is indicated in an inter-UE coordination message, so that a plurality of UEs receiving the inter-UE coordination message may determine, according to a priority indicated when a resource corresponding to the coordination resource (e.g., a resource coinciding with the coordination resource) was allocated and/or reserved thereby, whether to drop the coordination resource, thereby alleviating the problem of resource conflict in a distributed resource reservation mechanism, and improving resource utilization efficiency.

### BRIEF DESCRIPTION OF THE DRAWINGS

The above and other features of the present invention will be more apparent from the following detailed description in combination with the accompanying drawings, in which:

FIG. 1 is a schematic diagram showing an example of a reference resource grid and definitions of reference resources therein.

FIG. 2 is a flowchart showing a method performed by user equipment according to Embodiment 1 of the present invention.

FIG. 3 is a flowchart showing a method performed by user equipment according to Embodiment 2 of the present invention.

FIG. 4 shows a block diagram of user equipment (UE) according to the present invention.

### DETAILED DESCRIPTION

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

In the following description, a 5G mobile communication system and its later evolved versions are used as exemplary application environments to set forth a plurality of embodiments according to the present invention in detail. However, it is to be noted that the present invention is not limited to the following embodiments, but is applicable to many other wireless communication systems, such as a communication system after 5G and a 4G mobile communication system before 5G.

Some terms involved in the present invention are described below. Unless otherwise specified, the terms used in the present invention adopt the definitions herein. The terms given in the present invention may vary in LTE, LTE-Advanced, LTE-Advanced Pro, NR, and subsequent communication systems, but unified terms are used in the present invention. When applied to a specific system, the terms may be replaced with terms used in the corresponding system.
3GPP: 3rd Generation Partnership Project
AGC: Automatic Gain Control
AMF: Access and Mobility Management Function
AS: Access Stratum
BWP: Bandwidth Part
CBR Channel Busy Ratio
CP: Cyclic Prefix
CP-OFDM: Cyclic Prefix Orthogonal Frequency Division Multiplexing
CRB: Common Resource Block
CSI: Channel-State Information
DFT-s-OFDM: Discrete Fourier Transformation Spread Orthogonal Frequency Division Multiplexing
DL: Downlink
DM-RS: also referred to as DMRS, Demodulation Reference Signal
eNB: E-UTRAN Node B
E-UTRAN: Evolved UMTS Terrestrial Radio Access Network
FDRA: Frequency Domain Resource Assignment
FR1: Frequency Range 1
FR2: Frequency Range 2
GLONASS: GLObal NAvigation Satellite System
gNB: NR Node B
GNSS: Global Navigation Satellite System
GPS: Global Positioning System
HARQ: Hybrid Automatic Repeat Request
HARQ-ACK: HARQ Acknowledgement
ID: Identity (or Identifier)
IE: Information Element
LTE: Long Term Evolution
LTE-A: Long Term Evolution-Advanced
MAC: Medium Access Control
MAC CE: MAC Control Element
MIB: Master Information Block
MIB-SL: Master Information Block-Sidelink
MIB-SL-V2X: Master Information Block-Sidelink-Vehicle to Everything
MIB-V2X: Master Information Block-Vehicle to Everything
MME: Mobility Management Entity
NAS: Non-Access Stratum
NDI: New Data Indicator
NR: “New Radio”, fifth generation radio access technology
OFDM: Orthogonal Frequency Division Multiplexing
P2V: Pedestrian-to-Vehicle
P2X: Pedestrian-to-everything
PBCH: Physical Broadcast Channel
PDCCH: Physical Downlink Control Channel
PDCP: Packet Data Convergence Protocol.
PSBCH: Physical Sidelink Broadcast Channel
PSCCH: Physical Sidelink Control Channel
PSFCH: Physical Sidelink Feedback Channel
PSSCH: Physical Sidelink Shared Channel
PRB: Physical Resource Block
PSS: Primary Synchronization Signal
PSS-SL: Primary Synchronization Signal for Sidelink
PSSS: Primary Sidelink Synchronization Signal
QZSS: Quasi-Zenith Satellite System
RB: Resource Block
RBG: Resource Block Group
RE: Resource Element
RLC: Radio Link Control
RRC: Radio Resource Control
RV: Redundancy Version
S-BWP: Sidelink Bandwidth Part
S-MIB: Sidelink Master Information Block
S-PSS: Sidelink Primary Synchronization Signal
S-SSB: Sidelink SS/PBCH Block (Sidelink Synchronization Signal/Physical Broadcast Channel Block)
S-SSS: Sidelink Secondary Synchronization Signal
SCI: Sidelink Control Information
SCS: Subcarrier Spacing
SIB: System Information Block
SL: Sidelink
SL BWP: Sidelink Bandwidth Part
SL MIB: Sidelink Master Information Block
SL PSS: Sidelink Primary Synchronization Signal
SL SS: Sidelink Synchronization Signal
SL SSID: Sidelink Synchronization Signal Identity (or Sidelink Synchronization Signal Identifier)
SL SSB: Sidelink SS/PBCH Block (Sidelink Synchronization Signal/Physical Broadcast Channel Block)
SL SSS: Sidelink Secondary Synchronization Signal
SL-SCH: Sidelink Shared Channel
SLSS: Sidelink Synchronization Signal
SLSS ID: Sidelink Synchronization Signal Identity (or Sidelink Synchronization Signal Identifier)
SLSSID: Sidelink Synchronization Signal Identity (or Sidelink Synchronization Signal Identifier)
SSB: SS/PBCH Block (Synchronization Signal/Physical Broadcast Channel Block)
SSB-SL: SS/PBCH Block for Sidelink (Sidelink Synchronization Signal/Physical Broadcast Channel Block)
SSS: Secondary Synchronization Signal
SSS-SL: Secondary Synchronization Signal for Sidelink
SSSB: Sidelink SS/PBCH Block (Sidelink Synchronization Signal/Physical Broadcast Channel Block)
SSSS: Secondary Sidelink Synchronization Signal
Sub-channel Sub-channel
S-GW: Serving Gateway
TB: Transport Block
UE: User Equipment
UL: Uplink
UMTS: Universal Mobile Telecommunications System
UPF: User Plane Function
V2I: Vehicle-to-Infrastructure
V2N: Vehicle-to-Network
V2P: Vehicle-to-Pedestrian
V2V: Vehicle-to-Vehicle
V2X: Vehicle-to-Everything
VRB: Virtual Resource Block

Unless otherwise specified, in all embodiments and implementations of the present invention:
Optionally, “the first slot in the slot set S later than the slot n” refers to the first slot that is in the slot set S and that is temporally later than the slot n. The slot n may be in the slot set S, or may not be in the slot set S. For example, if the slot set S={1, 3, 5}, and the slot n=2, then the first slot in the slot set S later than the slot n is the slot 3. As another example, if the slot set S={1, 3, 5}, and the slot n=3, then the first slot in the slot set S later than the slot n is the slot 5.
Optionally, “the first slot in the slot set S not earlier than the slot n” refers to the first slot that is in the slot set S and that is temporally not earlier than the slot n. The slot n may be in the slot set S, or may not be in the slot set S. For example, if the slot set S={1, 3, 5}, and the slot n=2, then the first slot in the slot set S not earlier than the slot n is the slot 3. As another example, if the slot set S={1, 3, 5}, and the slot n=3, then the first slot in the slot set S not earlier than the slot n is the slot 3.
Optionally, “the last slot in the slot set S earlier than the slot n” refers to the last slot that is in the slot set S and that is temporally earlier than the slot n. The slot n may be in the slot set S, or may not be in the slot set S. For example, if the slot set S={1, 3, 5}, and the slot n=4, then the last slot in the slot set S earlier than the slot n is the slot 3. As another example, if the slot set S={1, 3, 5}, and the slot n=5, then the last slot in the slot set S earlier than the slot n is the slot 3.
Optionally, “the last slot in the slot set S not later than the slot n” refers to the last slot that is in the slot set S and that is temporally not later than the slot n. The slot n may be in the slot set S, or may not be in the slot set S. For example, if the slot set S={1, 3, 5}, and the slot n=4, then the last slot in the slot set S not later than the slot n is the slot 3. As another example, if the slot set S={1, 3, 5}, and the slot n=3, then the last slot in the slot set S not later than the slot n is the slot 3.
Optionally, “send” and “transmit” are interchangeable with each other where applicable.
Optionally, “symbol” may refer to an OFDM symbol where applicable.
Optionally, any two of “within X”, “in X”, and “on X” are interchangeable with each other where applicable (for example, when one or more operations are performed on one or more resources). X may be one or more carriers (e.g., an SL carrier), or one or more BWPs (e.g., an SL BWP), or one or more resource pools (or sidelink resource pools), or one or more links (e.g., a UL, a DL, or an SL), or one or more channels (e.g., a PSSCH), or one or more sub-channels, or one or more RBGs, or one or more RBs, or one or more “occasions” (e.g., a PDCCH monitoring occasion, a PSSCH transmission occasion, a PSSCH reception occasion, a PSFCH transmission occasion, a PSFCH reception occasion, or the like), or one or more OFDM symbols, or one or more slots, or one or more subframes, or one or more half-frames, or one or more frames, or one or more arbitrary time-domain and/or frequency-domain and/or code-domain and/or spatial-domain resources, etc.
Optionally, “higher layer” may refer to one or more protocol layers or protocol sub-layers above a physical layer. For example, a MAC layer, an RLC layer, a PDCP layer, a PC5RRC layer, a PC5-S layer, an RRC layer, a V2X layer, an application layer, a V2X application layer, or the like.
Optionally, “pre-configure” may be pre-configuration performed in a higher-layer protocol, such as pre-configured in a specific storage location in the UE (for example, pre-configured according to the specification of the higher layer protocol), or pre-configured in a specific storage location that can be accessed by the UE (for example, pre-configured according to the specification of the higher layer protocol).
Optionally, “configuration” may be configuration performed in a higher layer protocol via signaling. For example, configuration is performed for the UE by means of RRC signaling.
Optionally, “configured” may be replaced with “pre-configured”. Vice versa.
Optionally, “configured” may be replaced with “configured or pre-configured”. Vice versa.
Optionally, “a certain parameter has been configured” may be replaced with “a certain parameter has been provided”. Vice versa.
Optionally, “indicating certain information by means of a certain parameter” may be replaced with “providing certain information by means of a certain parameter”. Vice versa.
Optionally, “providing certain information by means of a certain parameter” may be replaced with “configuring certain information by means of a certain parameter”. Vice versa.

Optionally, “a certain parameter is configured” may be replaced with “a certain parameter is signaled”. Vice versa.
Optionally, “not configured” may be replaced with “not pre-configured”. Vice versa.
Optionally, “not configured” may be replaced with “not configured and/or not pre-configured”. Vice versa.
Optionally, “not configured” may be replaced with “not (pre-)configured”. Vice versa.
Optionally, the parameter X may refer to “X-r8”, or “X-r9” or “X-r10”, or “X-r11” or “X-r12” or “X-r13” or “X-r14” or “X-r15” or “X-r16”, or “X-r17”, or the like where applicable (e.g., in the case that no ambiguity is caused). Vice versa. For example, “pdsch-HARQ-ACK-CodebookList” may be used to refer to a parameter “pdsch-HARQ-ACK-CodebookList-r16” where applicable. Vice versa.
Optionally, a time-domain resource may also be referred to as a time resource.
Optionally, a frequency-domain resource may also be referred to as a frequency resource.
Optionally, the resource block may refer to a virtual resource block (VRB), or may refer to a physical resource block (PRB), or may refer to a common resource block (CRB), or may refer to a resource block defined in another manner.
Optionally, frequency domain resource numbers may start from 0. For example, if the number of sub-channels (or subchannels) configured in a resource pool is N_{subChannel}^{SL}, a set of sub-channels in the resource pool may be represented by a set of corresponding sub-channel numbers as {0, 1, . . . , N_{subChannel}^{SL}−1}. As another example, a set of subcarriers in a resource block may be represented by a set of corresponding subcarrier numbers as {0, 1, . . . , 11}.
Optionally, time domain resource numbers may start from 0. For example, for 30 kHz SCS, a set of slots in a subframe may be represented by a set of corresponding slot indexes as {0, 1}.
Optionally, “SL transmission” may refer to one or more of the following given items, or any one of:
   PSSCH transmission.
   PSCCH and PSSCH transmission.
   PSCCH or PSSCH transmission.
   PSFCH transmission.
   S-SSB Transmission.
Optionally, “PSSCH transmission” may be replaced with “PSCCH and/or PSSCH transmission” or replaced with “PSCCH/PSSCH transmission”.

In communication based on device to device (D2D) technology, an interface between devices (also referred to as user equipment (UE)) may be referred to as a PC5 interface. A corresponding transmission link on a physical layer may be referred to as a “direct link” or “sidelink” (SL for short) so as to be distinguished from an uplink (UL for short) and a downlink (DL for short). Communication based on an SL may be referred to as sidelink (SL) communication, and a corresponding carrier may be referred to as an SL carrier. An SL based on LTE technology may be referred to as an LTE SL. An SL based on NR technology may be referred to as an NR SL. 5G V2X communication may be based on an LTE SL or an NR SL. Hereinafter, “SL” refers to an NR SL, “SL communication” refers to NR SL communication, and “V2X communication” refers to NR SL-based V2X communication unless otherwise specified.

A physical layer of an SL can support transmissions in one or more modes, such as broadcast transmission, groupcast transmission, unicast transmission, and the like, in one or more of in-coverage, out-of-coverage, and partial-coverage scenarios.

For frequency range 1 (FR1), a subcarrier spacing (SCS, denoted as Δf, in units of kHz) corresponding to the SL may be 15 kHz (normal CP), or 30 kHz (normal CP), or 60 kHz (normal CP or extended CP). For frequency range 2 (FR2), an SCS corresponding to the SL may be 60 kHz (normal CP or extended CP), or 120 kHz (normal CP). Each SCS corresponds to one SCS configuration (denoted as μ). For example, Δf=15 kHz corresponds to μ=0, Δf=30 kHz corresponds to μ=1, Δf=60 kHz corresponds to μ=2, Δf=120 kHz corresponds to μ=3, and so on. As another example, for any given μ, Δf=2 μ·15 kHz. μ may be an SCS configuration of an SL carrier. For example, all SL transmissions in one SL carrier use the same SCS configuration and/or the same CP. μ may be an SCS configuration of a sidelink bandwidth part (SL BWP, or referred to as S-BWP, or referred to as SBWP, or referred to as SL-BWP, or referred to as BWP-SL, or referred to as BWP for short). For example, all SL transmissions in one SL BWP use the same SCS configuration and/or the same CP. μ may be an SCS configuration of a resource pool. For example, all SL transmissions in one resource pool use the same SCS configuration and/or the same CP.

Signals and channels related to SL operations may include:
an SL PSS (sidelink primary synchronization signal), or referred to as an S-PSS, or referred to as an SPSS, or referred to as an SL-PSS, or referred to as a PSS-SL, or referred to as a PSSS (primary sidelink synchronization signal), or the like;
an SL SSS (sidelink secondary synchronization signal), or referred to as an S-SSS, or referred to as an SSSS (sidelink secondary synchronization signal), or referred to as an SL-SSS, or referred to as an SSS-SL, or referred to as an SSSS (secondary sidelink synchronization signal), or the like;
a PSBCH (physical sidelink broadcast channel);
a PSCCH (physical sidelink control channel);
a PSSCH (physical sidelink shared channel); and
a PSFCH (physical sidelink feedback channel).

The SL PSS, the SL SSS, and the PSBCH may be organized together into a block on a time/frequency resource. The block is referred to as, for example, an S-SSB (sidelink synchronization signal/PSBCH block, or SSS/PSBCH block), or is referred to as an SSS/PSBCH block, or is referred to as an SS/PSBCH block, or is referred to as an S-SS/PSBCH block, or is referred to as an SL SSB, or is referred to as an SSSB, or is referred to as an SL-SSB, or is referred to as an SSB-SL. A transmission bandwidth (for example, 11 resource blocks) of the S-SSB may be located in a corresponding SL carrier (for example, located in one SL BWP configured in the SL carrier). The SL PSS and/or the SL SSS may carry an SL SSID (sidelink synchronization identity, or sidelink synchronization identifier, or sidelink synchronization signal identity, or sidelink synchronization signal identifier, or sidelink identity, or physical-layer sidelink identity, or referred to as SL-SSID, or referred to as SSID-SL, or referred to as SLSSID, or referred to as SLSS ID, or referred to as S-SSID, or the like), and the PSBCH may carry an SL MIB (sidelink master information block, or referred to as SL-MIB, or referred to as S-MIB, or referred to as MIB-SL, or referred to as MasterInformationBlockSidelink), which is configured by means of, for example, a parameter masterInformationBlockSidelink.

On the SL, a time-domain resource and/or a frequency-domain resource used to transmit the S-SSB may be configured by means of higher-layer parameter(s). For example, in the frequency domain, a location of the S-SSB in the frequency domain may be configured by means of a parameter absoluteFrequencySSB-SL (or a parameter sl-AbsoluteFrequencySSB). As another example, in the time domain, one or more synchronization configuration items may be configured by means of a parameter sl-SyncConfigList. In each synchronization configuration item, N_{period}^{S-SSB} S-SSBs within an S-SSB period having a length of 16 frames can be configured by means of a parameter numSSBwithinPeriod-SL (or a parameter sl-NumSSB-WithinPeriod). An index of a slot where an S-SSB having a number (or an index) of i_{S-SSB} (0≤i_{S-SSB}≤N_{period}^{S-SSB}−1) is located in the period having a length of 16 frames may be N_{offset}^{S-SSB}+Nᵢₙₜₑᵣᵥₐₗ^{S-SSB}·i_{S-SSB}, wherein N_{offset}^{S-SSB} may be configured by means of a parameter timeOffsetSSB-SL (or a parameter sl-TimeOffsetSSB), and Nᵢₙₜₑᵣᵥₐₗ^{S-SSB} may be configured by means of a parameter timeIntervalSSB-SL (or a parameter sl-TimeInterval).

A synchronization source (or referred to as a synchronization reference, or referred to as a synchronization reference source) related to SL synchronization may include a GNSS (global navigation satellite system, a gNB, an eNB, and UE (for example, NR UE, or LTE UE, or NR UE or LTE UE). UE serving as a synchronization source (for example, UE transmitting the S-SSB) may be referred to as SyncRef UE.

Examples of the GNSS may include the GPS (Global Positioning System), the GLONASS (GLObal NAvigation Satellite System), the BeiDou (Beidou Navigation Satellite System), the Galileo (Galileo Navigation Satellite System), the QZSS (Quasi-Zenith Satellite System), etc.

One or more (for example, one) SL BWPs may be configured in the SL carrier. For each SL BWP, a starting symbol that can be used for SL transmission may be configured by means of a parameter startSLsymbols (or a parameter sl-StartSymbol) (for example, the symbol is numbered as lₛₜₐᵣₜ^{SL} in the slot), and the number of symbols that can be used for SL transmission may be configured by means of a parameter lengthSLsymbols (or a parameter sl-LengthSymbols) (for example, the number of symbols is denoted as N_{length}^{SL}). The N_{length}^{SL} symbols may be consecutive symbols. A value set of lₛₜₐᵣₜ^{SL} may be denoted as Sₛₜₐᵣₜ^{SL}, for example, a value set of Sₛₜₐᵣₜ^{SL}={0, 1, 2, 3, 4, 5, 6, 7}: N_{length}^{SL} may be denoted as S_{length}^{SL}, for example, S_{length}^{SL}={7, 8, 9, 10, 11, 12, 13, 14}. The “symbols that can be used for SL transmission” may be referred to as “SL symbols”. If a set of SL symbols (in chronological order) is denoted as {l₁^{SL}, l₂^{SL}, . . . , l_{N}_{_{length}}_{^{SL}}^{SL}}, then l₁^{SL}=lₛₜₐᵣₜ^{SL}, l₂^{SL}=lₛₜₐᵣₜ^{SL}+1, . . . , l_{N}_{_{length}}_{^{SL}}^{SL}=+lₛₜₐᵣₜ^{SL}+N_{length}^{SL}−1}. For example if lₛₜₐᵣₜ^{SL}=7 and N_{length}^{SL}=7, then the set of SL symbols is {7, 8, 9, 10, 11, 12, 13}.

Only a slot meeting a certain condition can be used for SL transmission. For example, at least the symbol lₛₜₐᵣₜ^{SL}, the symbol lₛₜₐᵣₜ^{SL}+1, . . . , and the symbol lₛₜₐᵣₜ^{SL}+N_{length}^{SL}−1 in the slot are uplink symbols (for example, a slot configured by means of tdd-UL-DL-ConfigurationCommon in servingCellConfigCommon in SIB1 and meeting the condition). As another example, the slot needs to be in a slot set of a configured resource pool.

One or more resource pools (or SL resource pools) may be configured in one SL BWP. In each resource pool,
in the frequency domain, the location of a starting resource block of a starting sub-channel of the resource pool in the SL BWP may be configured by means of a parameter startRB-Subchannel (or a parameter sl-StartRB-Subchannel).
In the frequency domain, each sub-channel may consist of one or more resource blocks, and the specific number of resource blocks (referred to as the size of the sub-channel, e.g., denoted as n_{subChannelSize}) may be configured by means of a parameter subchannelsize (or a parameter sl-SubchannelSize). The n_{subChannelSize} resource blocks may be consecutive in the frequency domain.
In the frequency domain, the number (denoted as N_{subch}^{SL}) of sub-channels occupied by the resource pool may be configured by means of a parameter numSubchannel (or a parameter sl-NumSubchannel). The N_{subch}^{SL} sub-channels may be consecutive in the frequency domain.
In the frequency domain, the number (denoted as N_{PRB}^{SL}) of PRBs occupied by the resource pool may be configured by means of a parameter sl-RB-Number. Optionally, the UE may assume that the last N_{PRB}^{SL} mod N_{subch}^{SL} RBs in the N_{PRB}^{SL} PRBs are not to be used.
In the frequency domain, in the order from low frequency to high frequency, sub-channels in a resource pool may be respectively numbered as 0, 1, . . . , N_{subch}^{SL}−1. A sub-channel numbered as i may be referred to as “sub-channel i” (0≤i≤N_{subch}^{SL}−1).
In the time domain, a slot bitmap may be configured by means of a parameter timeresourcepool (or a parameter sl-TimeResource) to indicate which one or more slots in a set of candidate slots belong to the resource pool. It can be seen that two consecutive slots in a resource pool may not be temporally consecutive (e.g., slots 0 and 6 within one frame may be two consecutive slots in a resource pool). For convenience, a set of all slots within one SFN period (or one DFN period) (e.g., from SFN 0 to SFN 1023, or from DFN 0 to DFN 1023) in a resource pool u may be denoted as

$$\{ {t}_{0}^{{′}^{SL , u}} , {t}_{1}^{{′}^{SL , u}} , … , {t}_{{T}_{max}^{{′}^{u}} - 1}^{{′}^{SL , u}} \} ,$$

wherein T′ₘₐₓ^{μ} is the number of slots in the slot set.
The set

$$\{ {t}_{0}^{{′}^{SL , u}} , {t}_{1}^{{′}^{SL , u}} , … , {t}_{{T}_{max}^{{′}^{u}} - 1}^{{′}^{SL , u}} \}$$

is a subset of a set of all slots within one SFN period (or one DFN period) (i.e., {0, 1, . . . , 10240×2^{μ}^{_{SL}}−1}). μ_{SL} is the SCS of a corresponding SL.

A resource pool may be configured to be a “transmission resource pool”, and resources therein may be used for data transmission and/or HARQ-ACK information reception in SL communication, etc.

A resource pool may also be configured to be a “reception resource pool”, and resources therein may be used for data reception and/or HARQ-ACK information transmission in SL communication, etc.

Methods for allocating resources (such as time-domain resources, or frequency-domain resources, or code-domain resources, or spatial-domain resources) related to SL operations may include:
Mode 1 (or Resource Allocation Mode 1, or Sidelink Resource Allocation Mode 1): a base station schedules a resource for SL transmission.
Mode 2 (or Resource Allocation Mode 2, or Sidelink Resource Allocation Mode 2): UE determines a resource for SL transmission (i.e., the base station does not participate in scheduling of any resource for SL transmission). For example, UE performing an SL transmission operation autonomously determines a resource for SL transmission.

The UE may schedule data transmission by means of sidelink control information (SCI). The SL operations may support “two-stage SCI”. 1^{st}-stage SCI may include information such as resource reservation and/or resource assignment, so that all UEs monitoring the SL may perform sensing with respect to a resource reservation and/or resource allocation status. 2^{nd}-stage SCI may include other information, such as information related to HARQ feedback and the like. Hereinafter, unless otherwise specified, when mentioned individually, “SCI” may refer to the 1^{st}-stage SCI, or the 2^{nd}-stage SCI, or the 1^{st}-stage SCI and the 2^{nd}-stage SCI.

A format of the 1^{st}-stage SCI may be SCI format 1-A (or written as “SCI format 1_A”). The following are some examples of the information that can be included in the SCI format 1-A:
priority;
frequency resource assignment; The maximum value (e.g., denoted as Nᵣₑₛ^{max}) of the number of resources allocated and/or reserved in each SCI may be configured or pre-configured by a higher layer protocol.
time resource assignment;
a resource reservation period; and
DMRS pattern.
a 2^{nd}-stage SCI format.

A format of the 2^{nd}-stage SCI may be SCI format 2-A (or written as “SCI format 2_A”) or SCI format 2-B (or written as “SCI format 2_B”). The following are some examples of the information that can be included in the SCI format 2-A and/or SCI format 2-B:
a source layer-1 identifier (source layer-1 ID, or referred to as layer-1 source ID, or referred to as physical layer source ID, or referred to as source ID (when the context is clear));
a destination layer-1 identifier (destination layer-1 ID, or referred to as layer-1 destination ID, or referred to as physical layer destination ID, or referred to as destination ID (when the context is clear));
an HARQ process identifier (HARQ process ID), or an HARQ process number;
a new data indicator (NDI); and
a redundancy version (RV).

The 1^{st}-stage SCI may be carried on a PSCCH. The 2^{nd}-stage SCI may be multiplexed, together with data to be transmitted, on a PSSCH associated with (or scheduled by) the PSCCH. The PSCCH and the PSSCH associated therewith may be multiplexed, in a certain manner, on the time-domain resource and/or the frequency-domain resource allocated for SL transmission (for example, a sub-channel where a starting resource block of the PSCCH is located is a starting sub-channel of the PSSCH associated therewith. For another example, the starting resource block of the PSCCH is a starting resource block of the starting sub-channel of the PSSCH associated therewith). In addition, it may be considered that the 1^{st}-stage SCI and/or the corresponding 2^{nd}-stage SCI schedules the PSSCH (or schedules transmission of the PSSCH, or schedules transmission of a TB carried on the PSSCH).

For an SL transmission including a PSCCH and/or a PSSCH, a transmitter may be referred to as TX UE, and a receiver may be referred to as RX UE. If HARQ feedback is enabled, the RX UE may feed back information (e.g., referred to as “HARQ-ACK information”) related to PSCCH and/or PSSCH reception by means of a PSFCH. For example, when the RX UE receives a PSSCH in a resource pool, and the value of the “HARQ feedback enabled/disabled indicator” field in the corresponding SCI is 1, the RX UE provides HARQ-ACK information via PSFCH transmission in the resource pool. Such HARQ-ACK information may be referred to as “HARQ-ACK information reported on the SL and related to the SL transmission”. In some configurations, the HARQ-ACK information reported on the SL and related to the SL transmission may indicate a positive acknowledgement (ACK or acknowledgement) indicating, for example, that data carried by a corresponding PSCCH and/or PSSCH can be correctly decoded, or may indicate a negative acknowledgement (NACK or NAK) indicating, for example, that data carried by a corresponding PSCCH and/or PSSCH cannot be correctly decoded. In some other configurations, the HARQ-ACK information reported on the SL and related to the SL transmission may indicate only NACK (for example, no HARQ-ACK feedback is transmitted when data carried by a corresponding PSCCH and/or PSSCH can be correctly decoded, and NACK is transmitted when data carried by a corresponding PSCCH and/or PSSCH cannot be correctly decoded). “ACK” and “NACK” may be referred to as HARQ-ACK values.

A RX UE, when performing SL reception, may receive only PSCCH and/or PSSCH transmission meeting an SL reception condition. The SL reception condition may be one or more of the following:
The combination of a source layer-1 identifier and/or a destination layer-1 identifier and/or a cast type (e.g., unicast, groupcast, or broadcast) determined according to SCI is consistent with one combination (e.g., one of one or more combinations) of a source layer-1 identifier and/or a destination layer-1 identifier and/or a cast type allowed for reception in the RX UE.
A source layer-2 identifier and/or a destination layer-2 identifier and/or a cast type determined according to SCI and/or a corresponding MAC PDU subheader is consistent with one combination (e.g., one of one or more combinations) of a source layer-2 identifier and/or a destination layer-2 identifier and/or a cast type allowed for reception in the RX UE.

In the time domain, PSFCH resources may recur periodically in a resource pool. For example, a corresponding period (referred to as, for example, “PSFCH period” or “PSFCH resource period,” e.g., denoted as N_{PSSCH}^{PSFCH}, and in units of, for example, the number of slots) may be configured by means of a parameter periodPSFCHresource (or a parameter sl-PSFCH-Period), and configured to be, for example, N_{PSSCH}^{PSFCH}=0, or N_{PSSCH}^{PSFCH}=1, or N_{PSSCH}^{PSFCH}=2, or N_{PSSCH}^{PSFCH}=4). N_{PSSCH}^{PSFCH}=0 may be used to indicate that no PSFCH resource is configured in a corresponding resource pool. For example, if a resource pool is not configured with any PSFCH-related parameter (such as a parameter sl-PSFCH-Config, or one or more parameters in the parameter sl-PSFCH-Config), or if the PSFCH period configured in the parameter sl-PSFCH-Config is 0, then it is indicated that the resource pool is not configured with any PSFCH resource. As another example, if a resource pool is configured with the parameter sl-PSFCH-Config, and if the PSFCH period configured in the parameter sl-PSFCH-Config is not 0, then it is indicated that the resource pool is configured with a PSFCH resource.

A slot configured with a PSFCH resource may be referred to as “PSFCH slot”. Within one PSFCH slot, symbols related to PSFCH transmission may be the last one or more SL symbols of the slot, e.g., for PSFCH format 0, the last three SL symbols (e.g., symbol lₛₜₐᵣₜ^{SL}+N_{length}^{SL}−3, symbol is lₛₜₐᵣₜ^{SL}+N_{length}^{SL}−2, and symbol lₛₜₐᵣₜ^{SL}+N_{length}^{SL}−1)) may be used. The symbol lₛₜₐᵣₜ^{SL}+N_{length}^{SL}−3 may be used for AGC, and content transmitted on this symbol may be copied from content transmitted on the symbol lₛₜₐᵣₜ^{SL}+N_{length}^{SL}−2. the symbol lₛₜₐᵣₜ^{SL}+N_{length}^{SL}−2 may be used for PSFCH transmission. The symbol lₛₜₐᵣₜ^{SL}+N_{length}^{SL}−1 may be used as a gap symbol, or a guard symbol. Other SL symbols for a PSFCH slot may be used to transmit other SL signals/channels, such as a PSCCH, a PSSCH, etc.

In SL resource allocation mode 2, allocated SL resources may be determined by using one or more methods. For example, a set of “available resources” (or “idle resources”) may be determined by using different methods, and then one or more SL resources for SL transmission are selected (e.g., randomly selected) from the set of the “available resources” (or “idle resources”). In embodiments and implementations of the present invention, a method for determining a set of “available resources” may be referred to as “resource selection mechanism” or “resource selection method” or “resource selection scheme” or “resource determination mechanism” or “resource determination method” or “resource determination scheme” or “resource allocation mechanism” or “resource allocation method” or “resource allocation scheme” or the above names added with the prefix “SL” (such as “SL resource selection mechanism”), or the like. Alternatively, a set of all operations for determining allocated SL resources is referred to as “resource selection mechanism”. Alternatively, a set of some operations for determining allocated SL resources is referred to as “resource selection mechanism”.

Using a certain resource selection mechanism in SL resource allocation mode 2 may be referred to as performing SL resource allocation mode 2 on the basis of the resource selection mechanism.

Operations corresponding to SL resource allocation mode 2 may include: in a slot n, requesting, by a higher layer protocol entity (e.g., a MAC layer protocol entity), a physical layer protocol entity to determine, according to an input parameter set (e.g., denoted as P_{A}), a resource subset (e.g., denoted as S_{A}) from which resource(s) may be selected, and reporting, by the physical layer protocol entity, the resource subset S_{A} to the higher layer protocol entity (e.g., the MAC layer protocol entity).

The input parameter set P_{A} may include one or more of the following:
A resource pool (e.g., denoted as uₛₑₗ) for performing resource selection. For example, the resource subset S_{A} may be a subset of a set of candidate resources in the resource pool uₛₑₗ.
A priority (e.g., a layer-1 priority, or a physical layer priority, e.g., denoted as prio_{TX}).
A remaining packet delay budget.
A resource size. For example, the “resource size” may include the number of sub-channels occupied by each resource (e.g., the number of consecutive sub-channels), e.g., denoted as L_{subCH}. As another example, the “resource size” may include the number of slots occupied by each resource (e.g., the number of consecutive slots), e.g., denoted as Lₛₗₒₜ. Optionally, L_{subCH} and/or Lₛₗₒₜ may be a predefined or configured or pre-configured value, e.g., Lₛₗₒₜ=1 (in this case, the resource may be referred to as a single-slot resource).
A resource reservation interval, e.g., denoted as P_{rsvp_TX}.
A resource set for a re-evaluation operation, e.g., denoted as (r₀, r₁, r₂, . . . ).
A resource set for a pre-emption operation, e.g., denoted as (r′₀, r′₁, r′₂, . . . ).

To determine the resource subset S_{A}, the set S_{A} may be initialized as a set (e.g., denoted as Sₐₗₗ) consisting of all candidate resources, and then unavailable resources are removed from the set S_{A}, and the resulting set S_{A} is the requested resource subset.

The “set Sₐₗₗ consisting of all candidate resources” may be a set of all resources corresponding to L_{subCH} sub-channels and Lₛₗₒₜ slots in the resource pool uₛₑₗ and in a resource selection window (e.g., a time window corresponding to a time interval [n+T₁, n+T₂]), or a subset of the set (e.g., including only resources in a slot that can be used to transmit a PSCCH and/or a PSSCH, wherein, for example, in an SL symbol set configured in a certain slot in the resource pool uₛₑₗ, if the number of SL symbols that can be used to transmit a PSCCH and/or a PSSCH does not correspond to any PSSCH DMRS mode, then the slot cannot be used to transmit a PSCCH and/or a PSSCH). T₁ and T₂ may be two values determined by the UE and meeting a certain condition. For example, T₁ may be related to processing capabilities of the UE, and T₂ may be related to the remaining packet delay budget.

For a UE that is performing or is about to perform SL resource allocation mode 2, the “unavailable resources” removed from the set S_{A} may include one or more of the following:
A resource that cannot be used to perform SL transmission on the UE due to the limit of the transmission capability of the UE. For example, due to the limit of the number of simultaneous transmissions supported by the UE, the UE cannot perform SL transmission on an SL carrier corresponding to the set S_{A} when the UE is performing transmission on another carrier. As another example, due to the limit of carrier combinations supported by the UE, the UE cannot perform SL transmission on an SL carrier corresponding to the set S_{A} among SL carriers when the UE is performing transmission on another carrier. As another example, because a requirement on the time required for tuning to a certain resource corresponding to the set S_{A} in the SL carrier exceeds the capability of the UE, the UE cannot perform SL transmission on the resource.
An unavailable resource identified by the UE by means of a sensing operation. For example, resource reservation information (e.g., resource reservation information in SCI) transmitted on an SL (e.g., transmitted by another UE) is monitored, detected, or received, so as to determine a set of reserved resources, and/or a set of resources that cannot be determined as reserved or not reserved, and/or a set of resources that may result in a conflict, and/or a set of allocated resources, and/or a set of resources that cannot be allocated, etc.
An unavailable resource indicated by another UE or a base station. For example, another UE monitors, detects, or receives resource reservation information (e.g., resource reservation information in SCI) transmitted on an SL, so as to determine a set of reserved resources, and/or a set of resources that cannot be determined as reserved or not reserved, and/or a set of resources that may result in a conflict, and/or a set of allocated resources, and/or a set of resources that cannot be allocated, and/or a set of resources that are not preferentially allocated, etc. The other UE may indicate information related to these resources to the UE via signaling carried in the SL transmission.

The operations corresponding to SL resource allocation mode 2 may include: selecting, from the resource subset S_{A}, a resource for a PS SCH/PSCCH transmission (e.g., a PSSCH transmission, or a PSCCH transmission, or a PSSCH transmission and a PSCCH transmission multiplexed in the same resource).

The operations corresponding to SL resource allocation mode 2 may include: selecting, from the resource subset S_{A}, resources for a plurality of PSSCH/PSCCH transmissions.

The operations corresponding to SL resource allocation mode 2 may include: selecting, from the resource subset S_{A}, a transmission resource for a transport block, for example, selecting, from the resource subset S_{A}, a resource for an initial transmission of the transport block and each retransmission thereof.

The operations corresponding to SL resource allocation mode 2 may include: selecting, from the resource subset S_{A}, transmission resources for a plurality of transport blocks, for example, selecting, from the resource subset S_{A}, a resource for an initial transmission of each of the plurality of transport blocks and each retransmission thereof. In SL resource allocation mode 2, a “random selection” method may be used to select a resource from the resource subset S_{A}. For example, a resource is selected from the resource subset SA according to an equal probability method.

If a resource selection mechanism identifies an unavailable resource by means of a sensing operation, it can be considered that the resource selection mechanism is a “sensing-based resource selection mechanism”. The sensing operation may be “full sensing” (or simply “sensing”). For example, the UE must monitor all slots that are in a sensing window (e.g., a time window corresponding to a time interval [n−T₀, n−T_{proc,0}^{SL})) and belong to (or may belong to) the resource pool uₛₑₗ except the slots that cannot be monitored due to the limit of the capability of the UE (e.g., the slots that cannot be monitored during SL transmission due to half-duplex limitations) and/or some special slots (e.g., slots that cannot be used to transmit a PSCCH and/or a PSSCH).To may be configured by means of a higher-layer parameter (e.g., the parameter sl-Sensing Window), and T_{proc,0}^{SL} may be related to the processing capability of the UE. The corresponding resource selection mechanism may be referred to as “full-sensing based resource selection mechanism”, or “full-sensing based resource selection”, or simply “full sensing”, or simply, if no confusion will be caused, “sensing based resource selection mechanism”, or “sensing based resource selection”, or simply “sensing”.

The sensing operation may also be “partial sensing”. For example, the UE only needs to monitor some slots (e.g., some slots that occur periodically) that are in the sensing window and belong to (or may belong to) the resource pool uₛₑₗ. The corresponding resource selection mechanism may be referred to as “partial-sensing based resource selection mechanism”, or “partial-sensing based resource selection”, or simply “partial sensing”.

If a resource selection mechanism does not involve (or, does not perform) any sensing operation, it can be considered that the resource selection mechanism is “resource selection mechanism not based on sensing”. For example, the set S_{A} may be equal to the “set Sₐₗₗ consisting of all candidate resources”, or may be equal to a set acquired by removing some special sources from the “set Sₐₗₗ consisting of all candidate resources”. The special resources may include one or more of the following:
A resource in a slot that cannot be used to perform PSCCH/PSSCH transmission.
A resource that cannot be used to perform SL transmission thereon due to the limit of the transmission capability of the UE.
An unavailable resource indicated by another UE or a base station.

The corresponding resource selection mechanism may be referred to as “random resource selection”, or simply “random selection”, or a “random resource selection not based on sensing”.

There may also be “sensing-based random resource selection”. For example, in the sensing-based resource selection mechanism, if a sensing result cannot be applied due to a certain reason, or only part of a sensing result is applied, then the resource selection can be considered “sensing-based random resource selection”.

Different UEs may support different sets of resource selection mechanisms. For example, all UEs support “random resource selection”. As another example, some UEs support only “full sensing” and “random resource selection”. As another example, some UEs support only “partial sensing” and “random resource selection”. As another example, some UEs support “full sensing”, “partial sensing”, and “random resource selection”. The set of resource selection mechanisms supported by the UE may be referred to as M_{cap}.

In various SL resource selection mechanisms, it can be considered that “full sensing” consumes a relatively large amount of power (or energy), and is applicable to UEs not sensitive to power consumption (e.g., a UE mounted on an automobile in V2V communication). “Partial sensing”, “random resource selection”, etc. consume a relatively small amount of power, and are applicable to UEs sensitive to power consumption and/or communication scenarios sensitive to power consumption (e.g., a handheld device corresponding to a “pedestrian” in V2P communication). In another aspect, “random resource selection” may be used as an exception addressing mechanism or a fallback mechanism of another resource selection mechanism (e.g., “full sensing”) (e.g., in V2V communication, when no sensing result is temporarily available, fallback from “full sensing” to “random resource selection” may be performed). Hence, “random resource selection” may also be applied to UEs not sensitive to power consumption. Certainly, the disadvantage of SL resource selection mechanisms such as “partial sensing”, “random resource selection”, etc., is that the probability of conflicts between resources selected by different UEs is increased.

The SL resource selection mechanisms such as “partial sensing”, “random resource selection”, etc., may be applied to SL communication as part of “SL power saving” characteristics. For example, “partial sensing” can only be used when “SL power saving” is enabled (or activated, or configured), and the like.

When “SL power saving” is enabled, UE may be in one of a plurality of states (e.g., referred to as SL states, or SL modes, or SL communication methods, or the like) related to “SL power saving”, such as:
First SL state. For example, the first SL state may be an “SL non-power saving state”. For example, a UE in this SL state is not sensitive to power (or energy) consumption, and correspondingly, the used resource selection mechanism does not require particularly taking into consideration power (or energy) consumption. The first SL state may also be referred to as “first SL mode”, or “first SL communication method”, etc. The SL non-power saving state may also be referred to as “SL non-power saving mode”, or “SL non-power saving communication method”, etc. An example of the SL non-power saving communication method may be some specific V2X communication methods (e.g., V2V).
Second SL state. The second SL state may be an “SL power saving state”. For example, a UE in this SL state is relatively or extremely sensitive to power (or energy) consumption, and correspondingly, the used resource selection mechanism requires taking into consideration power (or energy) consumption. For example, use of a resource selection mechanism that has high power consumption is avoided or reduced. The second SL state may also be referred to as “second SL mode”, or “second SL communication mode”, etc. The SL power saving state may also be referred to as “SL power saving mode”, or “SL power saving communication method”, etc. An example of the SL power saving communication method may be some specific V2X communication methods (e.g., V2P). Another example of the SL power saving communication method may be an SL communication method used for public security.

“SL power saving” may be enabled (or “activated”, or “configured”) or disabled (or deactivated) by means of a higher layer protocol parameter (e.g., referred to as sl-powerSavingConfig). For example, if the parameter sl-powerSavingConfig is not present (or not configured), it is indicated that “SL power saving” is not enabled or is disabled. As another example, if the parameter sl-powerSavingConfig is present (or configured), it is indicated that “SL power saving” is enabled. As another example, if the value of the parameter sl-powerSavingConfig (or a certain parameter in an information element corresponding to the parameter sl-powerSavingConfig) is a predefined value (e.g., “disabled”, “false”, or the like), it is indicated that “SL power saving” is not enabled or is disabled. As another example, if the value of the parameter sl-powerSavingConfig (or a certain parameter in an information element corresponding to the parameter sl-powerSavingConfig) is a predefined value (e.g., “enabled”, “true”, or the like), it is indicated that “SL power saving” is enabled.

If “SL power saving” is not enabled, the UE may be considered to be always in the first SL state.

The set M_{cap} of resource selection mechanisms supported by the UE may be related to the SL state that the UE is in. For example, if the UE is in the first SL state, the set M_{cap} is equal to a set M_{cap,1}. As another example, if the UE is in the second SL state, the set M_{cap} is equal to a set M_{cap,2}. Optionally, the set M_{cap,1} and the set M_{cap,2} may be the same or different. For example, the set M_{cap,1} is {full sensing}. As another example, the set M_{cap,1} is {full sensing, random resource selection}. As another example, the set M_{cap,1} is {full sensing, partial sensing, random resource selection}. As another example, the set M_{cap,2} may be {random resource selection}. As another example, the set M_{cap,2} may be {partial sensing, random resource selection}.

An inter-UE coordination function can be supported in SL communication, and used for, for example, coordination in resource (e.g., SL resources) allocation between two or more UEs. Specifically, for example, a UE (e.g., referred to as UE A) may transmit an “inter-UE coordination message” to one or more other UEs. The “inter-UE coordination message” may carry (or indicate) one or more resource sets, and each resource set may be referred to as a “coordination resource set”. Each resource in a coordination resource set may be referred to a “coordination resource”. Each coordination resource set may be associated with one or more (e.g., one) resource pools.

An inter-UE coordination message may be triggered autonomously by a UE transmitting the inter-UE coordination message. For example, if UE A detects that resources respectively indicated (or reserved, or allocated) by UE B1 and UE B2 conflict with each other, UE A may transmit an inter-UE coordination message to indicate the presence of conflicting resources. The inter-UE coordination message may be transmitted in a broadcast or groupcast manner, or is respectively transmitted to UE B1 and UE B2 in a unicast manner

An inter-UE coordination message may be triggered by an “inter-UE coordination request message” transmitted by one or more other UEs. In this case, the inter-UE coordination message may also be referred to as “inter-UE coordination response message”.

An inter-UE coordination message may be a physical layer message. For example, the inter-UE coordination message may be included in SCI (e.g., 1^{st}-stage SCI, or 2^{nd}-stage SCI). As another example, the inter-UE coordination message may be multiplexed in a PSSCH (for example, the inter-UE coordination message and 2^{nd}-stage SCI and/or an SL-SCH may be multiplexed in the same PSSCH transmission). As another example, the inter-UE coordination message may be multiplexed in a PSCCH (for example, the inter-UE coordination message and 1^{st}-stage SCI may be multiplexed in the same PSCCH transmission).

An inter-UE coordination message may be a higher layer (e.g., the MAC layer, or the RRC layer) message. For example, the inter-UE coordination message may be carried in a MAC CE. As another example, the inter-UE coordination message may be an RRC message.

An inter-UE coordination request message may be a physical layer message. For example, the inter-UE coordination request message may be included in SCI (e.g., 1^{st}-stage SCI, or 2^{nd}-stage SCI). As another example, the inter-UE coordination request message may be multiplexed in a PSSCH (for example, the inter-UE coordination request message and 2^{nd}-stage SCI and/or an SL-SCH may be multiplexed in the same PSSCH transmission). As another example, the inter-UE coordination request message may be multiplexed in a PSCCH (for example, the inter-UE coordination request message and 1^{st}-stage SCI may be multiplexed in the same PSCCH transmission).

An inter-UE coordination request message may be a higher layer (e.g., the MAC layer, or the RRC layer) message. For example, the inter-UE coordination request message may be carried in a MAC CE. As another example, the inter-UE coordination request message may be an RRC message.

An inter-UE coordination message may correspond to a priority (e.g., referred to as “coordination message priority”). Optionally, the coordination message priority may be indicated in the corresponding inter-UE coordination message. Optionally, the coordination message priority may be related to a priority field in SCI associated with the inter-UE coordination message (e.g., 1^{st}-stage SCI carrying the inter-UE coordination message, or 1^{st}-stage SCI associated with 2^{nd}-stage SCI carrying the inter-UE coordination message, or 1^{st}-stage SCI associated with the PSSCH in which a MAC CE carrying the inter-UE coordination message is located, or 1^{st}-stage SCI associated with the PSSCH in which an RRC message corresponding to the inter-UE coordination message is located). For example, the value of the coordination message priority is equal to the value of a priority field in the SCI. Optionally, the coordination message priority may be independent of the priority field in the SCI associated with the inter-UE coordination message.

An inter-UE coordination request message may correspond to a priority (e.g., referred to as “coordination request message priority”). Optionally, the coordination request message priority may be indicated in the corresponding inter-UE coordination request message. Optionally, the coordination request message priority may be related to a priority field in SCI associated with the inter-UE coordination request message (e.g., 1^{st}-stage SCI carrying the inter-UE coordination request message, or 1^{st}-stage SCI associated with 2^{nd}-stage SCI carrying the inter-UE coordination request message, or 1^{st}-stage SCI associated with the PSSCH in which a MAC CE carrying the inter-UE coordination request message is located, or 1^{st}-stage SCI associated with the PSSCH in which an RRC message corresponding to the inter-UE coordination request message is located). For example, the value of the coordination request message priority is equal to the value of a priority field in the SCI. Optionally, the coordination request message priority may be independent of the priority field in the SCI associated with the inter-UE coordination request message.

Each coordination resource set in an inter-UE coordination message may respectively correspond to a priority (e.g., referred to as “coordination resource set priority”). Each coordination resource in a coordination resource set may correspond to a priority (e.g., referred to as “coordination resource priority”).

In a time window, a UE (e.g., referred to as UE B) may receive inter-UE coordination messages (e.g., respectively receiving these messages in different slots in the time window) transmitted by one or more other UEs (e.g., respectively referred to as UE A1, UE A2, . . . ). wherein
Optionally, the time window may be a time window that occurs periodically. A corresponding period may be a predefined value, or a value configured by a higher layer protocol, or a value pre-configured by a higher layer protocol.
Optionally, the time window may be related to one or more resource selections or resource allocations, wherein each resource selection or resource allocation may correspond to one or more PSCCH and/or PSSCH transmissions, or correspond to one or more transport blocks. For example, the time window may be related to a sensing window and/or a resource selection window corresponding to the one or more resource selections or resource allocations. Specifically, for example, the time window may be equal to a sensing window corresponding to one resource selection or resource allocation, or the time window may be equal to a resource selection window corresponding to one resource selection or resource allocation, or the time window may start at the starting time of a sensing window corresponding to one resource selection or resource allocation and end at the ending time of a corresponding resource selection window.
Optionally, UE B may process part or all of one or more inter-UE coordination messages received in the time window. For example, UE B processes all of the one or more inter-UE coordination messages. As another example, UE B processes an inter-UE coordination message having the highest coordination message priority in the one or more inter-UE coordination messages. As another example, if there is more than one inter-UE coordination message having the highest coordination message priority among the one or more inter-UE coordination messages, UE B selects (e.g., randomly selects) one of the inter-UE coordination messages having the highest coordination message priority to perform processing. As another example, if there is more than one inter-UE coordination message having the highest coordination message priority among the one or more inter-UE coordination messages, UE B processes all of the inter-UE coordination messages having the highest coordination message priority.
Optionally, for the one or more inter-UE coordination messages processed by UE B, UE B processes all coordination resource sets therein.
Optionally, if two inter-UE coordination messages processed by UE B include the same coordination resource set, UE B processes the coordination resource set having the higher priority therein.
Optionally, if two coordination resource sets respectively included in two inter-UE coordination messages processed by UE B include the same coordination resource (or overlapping coordination resources, e.g., overlapping on one or more REs), UE B processes the coordination resource set having the higher priority therein.
Optionally, if two coordination resources that are respectively from different inter-UE coordination messages and are processed by UE B are the same or overlap (e.g., overlapping on one or more REs), UE B processes the coordination resource having the higher priority therein.

In a time window, a UE (e.g., referred to as UE A) may receive inter-UE coordination request messages (e.g., respectively receiving these messages in different slots in the time window) transmitted by one or more other UEs (e.g., respectively referred to as UE A1, UE A2, . . . ). wherein
Optionally, the time window may be a time window that occurs periodically. A corresponding period may be a predefined value, or a value configured by a higher layer protocol, or a value pre-configured by a higher layer protocol.
Optionally, UE A may process part or all of one or more inter-UE coordination request messages received in the time window. For example, UE A processes all of the one or more inter-UE coordination request messages. As another example, UE A processes an inter-UE coordination request message having the highest coordination request message priority in the one or more inter-UE coordination request messages. As another example, if there is more than one inter-UE coordination request message having the highest coordination request message priority among the one or more inter-UE coordination request messages, UE A selects (e.g., randomly selects) one of the inter-UE coordination request messages having the highest coordination request message priority to perform processing. As another example, if there is more than one inter-UE coordination request message having the highest coordination request message priority among the one or more inter-UE coordination request messages, UE A processes all of the inter-UE coordination request messages having the highest coordination request message priority.
Optionally, for the one or more inter-UE coordination request messages processed by UE B, UE B processes all coordination resource sets therein.

The processing one inter-UE coordination request message may include: determining and transmitting one or more corresponding inter-UE coordination messages (or inter-UE coordination response messages).

Each coordination resource may correspond to a type (or a use). For example, a coordination resource indicated in an inter-UE coordination message transmitted from UE A to UE B may be one of the following:
“Preferred resource”. For example, if UE B transmits data to UE A by using one or more resources in a set of “preferred resources” determined by UE A, interference to UE A may be reduced, or the time when UE A cannot receive SL data is avoided.
“Non-preferred resource”. For example, if UE B transmits data to UE A by using one or more resources in a set of “non-preferred resources” determined by UE A, interference may be increased, or the time when UE A cannot receive SL data cannot be avoided.
“Resource having a detected conflict”. For example, if UE A detects that a past resource has been reserved by more than one UE including UE B, then UE A may add the resource to a set of “resources having a detected conflict”, and indicate the set to UE B by means of an inter-UE coordination message.
“Resource having a potential conflict” (or “a resource expected to have a conflict”). For example, if UE A detects that a future resource has been reserved by more than one UE including UE B, then UE A may add the resource to a set of “resources having a potential conflict”, and indicate the set to UE B by means of an inter-UE coordination message.

A coordination resource set may consist of “preferred resources”, or consist of “non-preferred resources”, or consist of “resources having a detected conflict”, or consist of “resources having a potential conflict”, or consist of “resources expected to have a conflict”, or may include one or more “preferred resources”, and/or one or more “non-preferred resources”, and/or one or more “resources having a detected conflict”, and/or one or more “resources having a potential conflict”, and/or one or more “resources expected to have a conflict”.

An inter-UE coordination message may indicate one or more coordination resource types, e.g., respectively indicating the type of each coordination resource in the inter-UE coordination message, or respectively indicating the type of each coordination resource set in the inter-UE coordination message (e.g., indicating that a certain coordination resource set consists of “preferred resources”).

A coordination resource indicated in an inter-UE coordination message may be determined by means of one or more SCIs detected on an SL (e.g., one or more SCIs detected in operations such as “sensing”). For example, it is determined according to a plurality of SCIs that a resource has been reserved by a plurality of other UEs. As another example, it is determined according to a plurality of SCIs that resources reserved by a plurality of other UEs overlap with each other (e.g., overlapping on one or more REs). The sizes of resources (e.g., the numbers of sub-channels) reserved by different UEs may be different from each other, and may even be greatly different from each other, so that in order to reduce overhead incurred for indicating a coordination resource and/or a coordination resource set, a coordination resource may not directly correspond to a resource reserved in SCI, but corresponds to a “reference resource” (or a canonical resource, or a standard resource, or a base resource, or a nominal resource, or a common resource). Each reference resource may have the same size in the time domain and/or the frequency domain and/or the code domain and/or the spatial domain, and the corresponding value may be determined according to one or more predefined or configured or pre-configured parameters. Different reference resources do not overlap with each other in the time domain and/or the frequency domain and/or the code domain and/or the spatial domain (e.g., not overlapping on any RE). Each resource pool may correspond to different reference resource parameters (e.g., a size and a location). All reference resources in a reference resource set may belong to the same resource pool.

For example, a reference resource in the resource pool u may be located in a reference resource grid defined or configured or pre-configured in the resource pool u. The reference resource grid (e.g., denoted as D) corresponds to one or more of the following parameters:
A reference resource grid starting slot (e.g., denoted as t₀^{D}) corresponds to the first slot (e.g., the first slot in forward temporal order) of the reference resource grid D.
A reference resource grid time domain length (or referred to as “reference resource grid time domain width”, or referred to as “reference resource grid time domain size”, e.g., denoted as Wₜᵢₘₑ^{D}, e.g., representing Wₜᵢₘₑ^{D} slots). The Wₜᵢₘₑ^{D} slots may be Wₜᵢₘₑ^{D} consecutive slots in the resource pool u.
A reference resource grid starting sub-channel (e.g., c₀^{D}) corresponds to the first sub-channel of the reference resource grid D (e.g., the first sub-channel in ascending order of frequencies, or referred to as the lowest sub-channel or the smallest sub-channel).
A reference resource grid frequency domain length (or referred to as “reference resource grid frequency domain width”, or referred to as “reference resource grid frequency domain size”, e.g., denoted as V_{freq}^{D}, e.g., representing V_{freq}^{D} sub-channels). The V_{freq}^{D} sub-channels may be V_{freq}^{D} consecutive sub-channels in the resource pool u.

Each reference resource in the reference resource grid D may occupy the same number of slots in the time domain (e.g., the number of consecutive slots in the resource pool u, e.g., denoted as T_{ref}, where T_{ref} may be a predefined value (e.g., T_{ref}=1), or a value configured by a higher layer protocol, or a value pre-configured by a higher layer protocol). Optionally, the time occupied by each reference resource in the time domain may also be represented in other units, such as OFDM symbols, or subframes, or half-frames, or frames, or milliseconds, or seconds.

Each reference resource in the reference resource grid D may occupy the same number of sub-channels in the frequency domain (e.g., the number of consecutive sub-channels in the resource pool u, e.g., denoted as F_{ref}, where F_{ref} may be a predefined value (e.g., F_{ref}=3), or a value configured by a higher layer protocol, or a value pre-configured by a higher layer protocol). Optionally, the time occupied by each reference resource in the time domain may also be represented in other units, such as resource blocks, or resource block groups, or subcarriers, or hertz, or kilohertz, or megahertz.

Each reference resource in the reference resource grid D may be assigned a unique number. For example, a reference resource where a reference resource grid starting slot t₀^{D} and a reference resource grid starting sub-channel c₀^{D} are located corresponds to the smallest number (e.g., 0 or 1), and the other reference resources are numbered first according to the time domain and then according to the frequency domain (or, first according to the frequency domain and then according to the time domain).

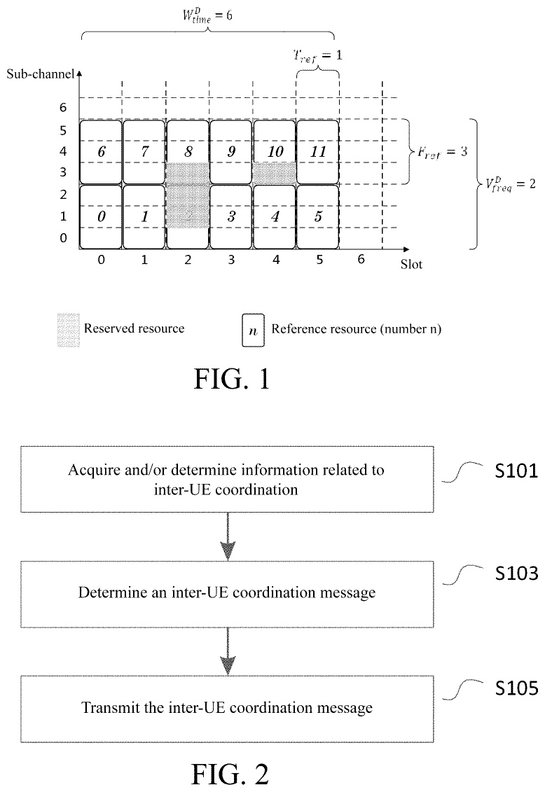

FIG. 1 is an example of the reference resource grid D. The number of slots of each reference resource in the time domain is T_{ref}=1, and the number of sub-channels of each reference resource in the frequency domain is F_{ref}=3. The reference resource grid time domain length Wₜᵢₘₑ^{D}=6. The reference resource grid frequency domain length V_{freq}^{D}=2. The reference resource grid starting slot t₀^{D} is the slot 0. The reference resource grid starting sub-channel c₀^{D} is the sub-channel 0. The reference resources are numbered first according to the time domain and then according to the frequency domain. In addition, FIG. 1 shows two reserved resources (e.g., indicated, or assigned, or reserved by means of the “frequency resource assignment” field and/or the “time resource assignment” field and/or the “resource reservation period” field in the SCI), wherein the first corresponds to a sub-channel set {1, 2, 3} in the slot 2, and the second corresponds to a sub-channel set {3} in the slot 4. Neither of the two resources is fully aligned with a boundary of any reference resource (or a combination of any two or more reference resources).

Each coordination resource in a coordination resource set may respectively correspond to one reference resource (e.g., represented by a reference resource number or a set including one reference resource number) in the reference resource grid D, or a combination of two or more reference resources (e.g., represented by a set of reference resource numbers). For example, a coordination resource set includes two coordination resources, wherein the first coordination resource corresponds to the reference resource 2 and the reference resource 8 in FIG. 1, and is represented as {2, 8}, and the second coordination resource corresponds to the reference resource 10 in FIG. 1, and is represented as {10}. As another example, a coordination resource set includes three coordination resources. The first coordination resource corresponds to the reference resource 2 in FIG. 1, and is represented as {2}. The second coordination resource corresponds to the reference resource 8 in FIG. 1, and is represented as {8}. The third coordination resource corresponds to the reference resource 10 in FIG. 1, and is represented as {10}.

The inter-UE coordination function may be activated (or “enabled”, or “configured”) or deactivated (or disabled) by means of a higher layer protocol parameter (e.g., referred to as sl-ueCoordConfig). For example, if the parameter sl-ueCoordConfig is not present (or not configured), it is indicated that the inter-UE coordination function is not activated. As another example, if the parameter sl-ueCoordConfig is present (or configured), it is indicated that the inter-UE coordination function is activated. As another example, if the value of the parameter sl-ueCoordConfig (or a certain parameter in an information element corresponding to the parameter sl-ueCoordConfig) is a predefined value (e.g., “disabled”, “false”, or the like), it is indicated that the inter-UE coordination function is not activated. As another example, if the value of the parameter sl-ueCoordConfig (or a certain parameter in an information element corresponding to the parameter sl-ueCoordConfig) is a predefined value (e.g., “enabled”, “true”, or the like), it is indicated that the inter-UE coordination function is activated.

### Embodiment 11

A method performed by user equipment according to Embodiment 1 of the present invention will be described below with reference to FIG. 2.

FIG. 2 is a flowchart showing a method performed by user equipment according to Embodiment 1 of the present invention.

As shown in FIG. 2, in Embodiment 1 of the present invention, steps performed by the user equipment (UE) include: part or all of step S101, step S103, and step S105.

Specifically, optionally, in step S101, information related to inter-UE coordination is acquired and/or determined.

Optionally, the “information related to inter-UE coordination” is applicable to SL resource allocation mode 2.

Optionally, part or all of the “information related to inter-UE coordination” is predefined information, or is determined according to predefined information.

Optionally, part or all of the “information related to inter-UE coordination” is configured in a higher layer protocol, or is determined according to configuration information of a higher layer protocol.

Optionally, part or all of the “information related to inter-UE coordination” is pre-configured in a higher layer protocol, or is determined according to pre-configuration information of a higher layer protocol.

Optionally, part or all of the “information related to inter-UE coordination” is indicated (e.g., indicted explicitly, or indicated implicitly) by an inter-UE coordination request message (e.g., an inter-UE coordination request message received in a slot n_{RX}^{src} in a resource pool u_{RX}^{src}), or is determined according to indication information in the inter-UE coordination request message. Optionally, the inter-UE coordination request message is transmitted by another UE (i.e., another UE which is different from the UE, e.g., referred to as UE B,).

The “information related to inter-UE coordination” includes a “coordination resource set type” (e.g., denoted as Y_{CO}^{src}). Optionally, the “coordination resource set type” Y_{CO}^{src} may be a predefined value (e.g., “a set of preferred resources”, or “a set of non-preferred resources”, or “a set of resources having a detected conflict”, or “a set of resources having a potential conflict”, or “a set of resources expected to have a conflict”), or a value configured by means of a higher layer protocol, or a value pre-configured by means of a higher layer protocol, or is indicated by the inter-UE coordination request message, or is determined according to indication information in the inter-UE coordination request message.

Optionally, the “information related to inter-UE coordination” includes information about a “coordination resource pool” (e.g., denoted as u_{CO}^{src}, a corresponding slot set being denoted as

$$\{ {t}_{0}^{{′}^{SL , {u}_{CO}^{src}}} , {t}_{1}^{{′}^{SL , {u}_{CO}^{src}}} , … , {t}_{{T}_{max}^{{′}^{{u}_{CO}^{src}}} - 1}^{{′}^{SL , {u}_{CO}^{src}}} \} ,$$

and T′ₘₐₓ^{u}^{_{CO}}^{^{src}} being the number of slots in the slot set). wherein
Optionally, the coordination resource pool u_{CO}^{src} is a predefined resource pool.
Optionally, the coordination resource pool u_{CO}^{src} is configured by means of a higher layer protocol.
Optionally, the coordination resource pool u_{CO}^{src} is pre-configured by means of a higher layer protocol.
Optionally, the coordination resource pool u_{CO}^{src} is indicated by the inter-UE coordination request message, or is determined according to indication information in the inter-UE coordination request message. Optionally, the coordination resource pool u_{CO}^{src} may be indicated explicitly (e.g., information about the coordination resource pool u_{CO}^{src} is included in the inter-UE coordination request message, and the information, for example, may include a resource pool ID corresponding to the resource pool u_{CO}^{src}, or an index of the resource pool ID), or may be indicated implicitly (e.g., u_{CO}^{src}=u_{RX}^{src}).
Optionally, the coordination resource pool u_{CO}^{src} is autonomously determined by the UE (e.g., in the absence of the inter-UE coordination request message, the coordination resource pool u_{CO}^{src} is autonomously determined by the UE in a manner implemented by the UE).

Optionally, the “information related to inter-UE coordination” includes a time domain size (e.g., represented by the number of consecutive slots, and e.g., denoted as T_{ref}^{src}) of each reference resource. Optionally, the “time domain size of each reference resource” T_{ref}^{src} may be a predefined value (e.g., T_{ref}^{src}=1), or a value configured by means of a higher layer protocol, or a value pre-configured by means of a higher layer protocol, or is indicated by the inter-UE coordination request message, or is determined according to indication information in the inter-UE coordination request message.

Optionally, the “time domain size of each reference resource” T_{ref}^{src} may use other units, such as the number of OFDM symbols, or the number of subframes, or the number of half-frames, or the number of frames, or the like.

Optionally, the “information related to inter-UE coordination” includes a frequency domain size (e.g., represented by the number of consecutive sub-channels, and e.g., denoted as F_{ref}^{src}) of each reference resource. Optionally, the “frequency domain size of each reference resource” F_{ref}^{src} may be a predefined value, or a value configured by means of a higher layer protocol, or a value pre-configured by means of a higher layer protocol, or is indicated by the inter-UE coordination request message, or is determined according to indication information in the inter-UE coordination request message.

Optionally, the “frequency domain size of each reference resource” F_{ref}^{src} may use other units, such as the number of resource blocks, or the number of resource block groups, or the number of subcarriers, or the like.

Optionally, the “information related to inter-UE coordination” includes a “coordination starting frequency” (e.g., denoted as c_{CO,start}^{src}, e.g., in units of sub-channels). Optionally, the coordination starting frequency c_{CO,start}^{src} may be represented by a sub-channel number in the coordination resource pool u_{CO}^{src}. For example, the coordination starting frequency c_{CO,start}^{src} is a starting sub-channel of the coordination resource pool u_{CO}^{src}, and is represented as, e.g., c_{CO,start}^{src}=0. Optionally, the coordination starting frequency c_{CO,start}^{src} may be a predefined value, or a value configured by means of a higher layer protocol, or a value pre-configured by means of a higher layer protocol, or is indicated by the inter-UE coordination request message, or is determined according to indication information in the inter-UE coordination request message.

Optionally, the coordination starting frequency c_{CO,start}^{src} may use other frequency units, such as resource blocks, or resource block groups, or subcarriers, or the like.

Optionally, the “information related to inter-UE coordination” includes a “coordination bandwidth” (e.g., denoted as v_{CO}^{src}, e.g., representing v_{CO}^{src} sub-channels). Optionally, the coordination bandwidth v_{CO}^{src} may correspond to one or more consecutive sub-channels in the coordination resource pool u_{CO}^{src}. For example, the coordination bandwidth v_{CO}^{src} is equal to the number of sub-channels (e.g., denoted as N_{subch}^{SL,u}^{_{CO}}^{^{src}} of the coordination resource pool u_{CO}^{src}, i.e., v_{CO}^{src}=N_{subch}^{SL,u}^{_{CO}}^{^{src}}. Optionally, the coordination bandwidth v_{CO}^{src} may be a predefined value, or a value configured by means of a higher layer protocol, or a value pre-configured by means of a higher layer protocol, or is indicated by the inter-UE coordination request message, or is determined according to indication information in the inter-UE coordination request message.

Optionally, the coordination bandwidth v_{CO}^{src} may use other units, such as the number of resource blocks, or the number of resource block groups, or the number of subcarriers, or the like.

Optionally, the “information related to inter-UE coordination” includes a “coordination starting slot” (e.g., denoted as n_{CO,start}^{src,abs}).

Optionally, the coordination starting slot n_{CO,start}^{src,abs} may correspond to a slot in the slot set of the coordination resource pool u_{CO}^{src}.

Optionally, the coordination starting slot n_{CO,start}^{src,abs} may be represented by a subscript of a corresponding element in the slot set of the coordination resource pool u_{CO}^{src}. For example, if the set element is t′ᵢ_{_{CO,start}}_{^{src,abs}}^{SL,u}, the coordination starting slot n_{CO,start}^{src,abs} may be represented by an integer i_{CO,start}^{src,abs}.

Optionally, the coordination starting slot n_{CO,start}^{src,abs} may be represented by a corresponding element in a set (i.e., {0, 1, . . . , 10240×2^{μ}^{_{SL}}−1}) of all slots in a corresponding SFN period (or DFN period). For example, if the set element is j_{CO,start}^{src,abs}, the coordination starting slot n_{CO,start}^{src,abs} may be represented by an integer j_{CO,start}^{src,abs}.

Optionally, the coordination starting slot n_{CO,start}^{src,abs} may be indicated by the inter-UE coordination request message. For example, the integer i_{CO,start}^{src,abs} is indicated in the inter-UE coordination request message. As another example, the integer j_{CO,start}^{src,abs} is indicated in the inter-UE coordination request message.

Optionally, the “information related to inter-UE coordination” includes a “coordination starting slot offset” (e.g., denoted as O_{CO,start}^{src,rel}, e.g., representing O_{CO,start}^{src,rel} slots). Optionally, the coordination starting slot offset O_{CO,start}^{src,rel} may be a predefined value, or a value configured by means of a higher layer protocol, or a value pre-configured by means of a higher layer protocol, or is indicated by the inter-UE coordination request message, or is determined according to indication information in the inter-UE coordination request message.

Optionally, the coordination starting slot n_{CO,start}^{src,abs} may be determined according to indication information in the inter-UE coordination request message. For example, the coordination starting slot n_{CO,start}^{src,abs} is determined according to a first starting slot (e.g., denoted as n_{start,1}^{src}) and the coordination starting slot offset O_{CO,start}^{src,rel}. wherein
Optionally, the first starting slot n_{start,1}^{src} may be a slot in the slot set of the coordination resource pool u_{CO}^{src}.
Optionally, the first starting slot n_{start,1}^{src} may be a slot in the slot set of the resource pool u_{RX}^{src}.
Optionally, the first starting slot n_{start,1}^{src} may be the slot u_{RX}^{src}, i.e., n_{start,1}^{src}=n_{RX}^{src}.
Optionally, the first starting slot n_{start,1}^{src} may be the first slot that is in the slot set of the coordination resource pool u_{CO}^{src} and that is later than the slot n_{RX}^{src}.
Optionally, the first starting slot n_{start,1}^{src} may be the first slot that is in the slot set of the coordination resource pool u_{CO}^{src} and that is not earlier than the slot n_{RX}^{src}.
Optionally, the first starting slot n_{start,1}^{src} may be determined in a manner implemented by the UE (e.g., in the absence of the inter-UE coordination request message).
Optionally, the coordination starting slot n_{CO,start}^{src,abs} may be the O_{CO,start}^{src,rel}-th slot that is in the slot set of the coordination resource pool u_{CO}^{src} and that is counted starting from the first starting slot n_{start,1}^{src} (including the first starting slot n_{start,1}^{src} or not including the first starting slot n_{start,1}^{src}).
Optionally, the coordination starting slot n_{CO,start}^{src,abs} may be the O_{CO,start}^{src,rel}+1-th slot that is in the slot set of the coordination resource pool u_{CO}^{src} and that is counted starting from the first starting slot n_{start,1}^{src} (including the first starting slot n_{start,1}^{src} or not including the first starting slot n_{start,1}^{src}).
Optionally, the coordination starting slot n_{CO,start}^{src,abs} may be the O_{CO,start}^{src,rel}−1-th slot that is in the slot set of the coordination resource pool u_{CO}^{src} and that is counted starting from the first starting slot n_{start,1}^{src} (including the first starting slot n_{start,1}^{src} or not including the first starting slot n_{start,1}^{src}).
Optionally, the coordination starting slot n_{CO,start}^{src,abs} may be the first slot that is in the slot set of the coordination resource pool u_{CO}^{src} and that is later than (or, not earlier than) the second starting slot (e.g., denoted as n_{start,2}^{src}). wherein
   Optionally, the second starting slot n_{start,2}^{src} may be the O_{CO,start}^{src,rel}-th slot that is in the slot set of the coordination resource pool u_{RX}^{src} and that is counted starting from the first starting slot n_{start,1}^{src} (including the first starting slot n_{start,1}^{src} or not including the first starting slot n_{start,1}^{src}).
   Optionally, the second starting slot n_{start,2}^{src} may be the O_{CO,start}^{src,rel}+1-th slot that is in the slot set of the coordination resource pool u_{RX}^{src} and that is counted starting from the first starting slot n_{start,1}^{src} (including the first starting slot n_{start,1}^{src} or not including the first starting slot n_{start,1}^{src}).
   Optionally, the second starting slot n_{start,2}^{src} may be the O_{CO,start}^{src,rel}−1-th slot that is in the slot set of the coordination resource pool u_{RX}^{src} and that is counted starting from the first starting slot n_{start,1}^{src} (including the first starting slot n_{start,1}^{src} or not including the first starting slot n_{start,1}^{src}).

Optionally, the “information related to inter-UE coordination” includes a “coordination ending slot” (e.g., denoted as n_{CO,end}^{src,abs}).

Optionally, the coordination ending slot n_{CO,end}^{src,abs} may correspond to a slot in the slot set of the coordination resource pool u_{CO}^{src}.

Optionally, the coordination ending slot n_{CO,end}^{src,abs} may be represented by a subscript of a corresponding element in the slot set of the coordination resource pool u_{CO}^{src}. For example, if the set element is t′ₗ_{_{CO,end}}_{^{src,abs}}^{SL,u}, the coordination ending slot n_{CO,end}^{src,abs} may be represented by an integer i_{CO,end}^{src,abs}.

Optionally, the coordination ending slot n_{CO,end}^{src,abs} may be represented by a corresponding element in a set (i.e., {0, 1, . . . , 10240×2^{μ}^{_{SL}}−1}) of all slots in a corresponding SFN period (or DFN period). For example, if the set element is j_{CO,end}^{src,abs}, the coordination ending slot n_{CO,end}^{src,abs} may be represented by an integer j_{CO,end}^{src,abs}.

Optionally, the coordination ending slot n_{CO,end}^{src,abs} may be indicated by the inter-UE coordination request message. For example, the integer i_{CO,end}^{src,abs} is indicated in the inter-UE coordination request message. As another example, the integer j_{CO,end}^{src,abs} is indicated in the inter-UE coordination request message.

Optionally, the “information related to inter-UE coordination” includes a “coordination ending slot offset” (e.g., denoted as O_{CO,end}^{src,rel}, e.g., representing O_{CO,end}^{src,rel} slots). Optionally, the coordination ending slot offset O_{CO,end}^{src,rel} may be a predefined value, or a value configured by means of a higher layer protocol, or a value pre-configured by means of a higher layer protocol, or is indicated by the inter-UE coordination request message, or is determined according to indication information in the inter-UE coordination request message.

Optionally, the coordination ending slot n_{CO,end}^{src,abs} may be determined according to indication information in the inter-UE coordination request message. For example, the coordination ending slot n_{CO,end}^{src,abs} is determined according to a first ending slot (e.g., denoted as n_{end,1}^{src}) and the coordination ending slot offset O_{CO,start}^{src,rel}. wherein
Optionally, the first ending slot n_{end,1}^{src} may be a slot in the slot set of the coordination resource pool u_{CO}^{src}.
Optionally, the first ending slot n_{end,1}^{src} may be a slot in the slot set of the resource pool u_{RX}^{src}.
Optionally, the first ending slot n_{end,1}^{src} may be the slot n_{RX}^{src}, i.e., n_{end,1}^{src}=n_{RX}^{src}.
Optionally, the first ending slot n_{end,1}^{src} may be the first slot that is in the slot set of the coordination resource pool u_{CO}^{src} and that is later than the slot n_{RX}^{src}.
Optionally, the first ending slot n_{end,1}^{src} may be the first slot that is in the slot set of the coordination resource pool u_{CO}^{src} and that is not earlier than the slot n_{RX}^{src}.
Optionally, the first ending slot n_{end,1}^{src} may be determined in a manner implemented by the UE (e.g., in the absence of the inter-UE coordination request message).
Optionally, the coordination ending slot n_{CO,end}^{src,abs} may be the O_{CO,end}^{src,rel}-th slot that is in the slot set of the coordination resource pool u_{CO}^{src} and that is counted starting from the first ending slot n_{end,1}^{src} (including the first ending slot n_{end,1}^{src} or not including the first ending slot n_{end,1}^{src}).
Optionally, the coordination ending slot n_{CO,end}^{src,abs} may be the O_{CO,end}^{src,rel}+1-th slot that is in the slot set of the coordination resource pool u_{CO}^{src} and that is counted starting from the first ending slot n_{end,1}^{src} (including the first ending slot n_{end,1}^{src} or not including the first ending slot n_{end,1}^{src}).
Optionally, the coordination ending slot n_{CO,end}^{src,abs} may be the O_{CO,end}^{src,rel}−1-th slot that is in the slot set of the coordination resource pool u_{CO}^{src} and that is counted starting from the first ending slot n_{end,1}^{src} (including the first ending slot n_{end,1}^{src} or not including the first ending slot n_{end,1}^{src}).
Optionally, the coordination ending slot n_{CO,end}^{src,abs} may be the first slot that is in the slot set of the coordination resource pool u_{CO}^{src} and that is later than (or, not earlier than) the second ending slot n_{end,2}^{src}. wherein
   Optionally, the second ending slot n_{end,2}^{src} may be the O_{CO,end}^{src,rel}-th slot that is in the slot set of the coordination resource pool u_{RX}^{src} and that is counted starting from the first ending slot n_{end,1}^{src} (including the first ending slot n_{end,1}^{src} or not including the first ending slot n_{end,1}^{src}).
   Optionally, the second ending slot n_{end,2}^{src} may be the O_{CO,end}^{src,rel}+1-th slot that is in the slot set of the coordination resource pool u_{RX}^{src} and that is counted starting from the first ending slot n_{end,1}^{src} (including the first ending slot n_{end,1}^{src} or not including the first ending slot n_{end,1}^{src}).
   Optionally, the second ending slot n_{end,2}^{src} may be the O_{CO,end}^{src,rel}−1-th slot that is in the slot set of the coordination resource pool u_{RX}^{src} and that is counted starting from the first ending slot n_{end,1}^{src} (including the first ending slot n_{end,1}^{src} or not including the first ending slot n_{end,1}^{src}).

Optionally, the “information related to inter-UE coordination” includes a “coordination resource window length” (e.g., denoted as w_{CO}^{src}, e.g., representing w_{CO}^{src} slots). Optionally, the coordination resource window length w_{CO}^{src} may be a predefined value, or a value configured by means of a higher layer protocol, or a value pre-configured by means of a higher layer protocol, or is indicated by the inter-UE coordination request message, or is determined according to indication information in the inter-UE coordination request message.

Optionally, the “information related to inter-UE coordination” includes a “first response time offset” (e.g., denoted as O_{TX,1}^{src}, e.g., representing O_{TX,1}^{src} slots). The first response time offset O_{TX,1}^{src} may be a predefined value, or a value configured by means of a higher layer protocol, or a value pre-configured by means of a higher layer protocol, or is indicated by the inter-UE coordination request message, or is determined according to indication information in the inter-UE coordination request message.

Optionally, the “information related to inter-UE coordination” includes a “second response time offset” (e.g., denoted as O_{TX,2}^{src}, e.g., representing O_{TX,2}^{src} slots). The second response time offset O_{TX,2}^{src} may be a predefined value, or a value configured by means of a higher layer protocol, or a value pre-configured by means of a higher layer protocol, or is indicated by the inter-UE coordination request message, or is determined according to indication information in the inter-UE coordination request message.

In addition, optionally, in step S103, an inter-UE coordination message is determined.

Optionally, a resource pool (e.g., denoted as u_{CO}^{TX}) for transmitting the inter-UE coordination message is u_{RX}^{src}, i.e., u_{CO}^{TX}=u_{RX}^{src}.

Optionally, the resource pool u_{CO}^{TX} is u_{CO}^{src}, i.e., u_{CO}^{TX}=u_{CO}^{src}.

Optionally, the inter-UE coordination message is transmitted once in the resource pool u_{CO}^{TX}.

Optionally, the inter-UE coordination message is transmitted one or multiple times in the resource pool u_{CO}^{TX}.

Optionally, a slot (e.g., denoted as a slot n_{CO,first}^{TX}) where the first (or, initial) PSCCH and/or PSSCH transmission corresponding to the inter-UE coordination message is located satisfies n_{CO,first}^{TX}≥n_{RX}^{src}+O_{TX,1}^{src}, or satisfies n_{CO,first}^{TX}>n_{RX}^{src}+O_{TX,1}^{src}, or satisfies n_{CO,first}^{TX}≥n_{RX}^{src}+O_{TX,1}^{src}−1, or satisfies n_{CO,first}^{TX}>n_{RX}^{src}+O_{TX,1}^{src}−1, or satisfies n_{CO,first}^{TX}≥n_{RX}^{src}+O_{TX,1}^{src}+1, or satisfies n_{CO,first}^{TX}>n_{RX}^{src}+O_{TX,1}^{src}+1. (If the inter-UE coordination message is transmitted only once in the resource pool u_{CO}^{TX}, the first PSCCH and/or PSSCH transmission is the only one PSCCH and/or PSSCH transmission corresponding to the inter-UE coordination message.)

Optionally, the slot n_{CO,first}^{TX} satisfies n_{CO,first}^{TX}≤n_{RX}^{src}+O_{TX,2}^{src}, or satisfies n_{CO,first}^{TX}<n_{RX}^{src}+O_{TX,2}^{src}, or satisfies n_{CO,first}^{TX}≤n_{RX}^{src}+O_{TX,2}^{src}−1, or satisfies n_{CO,first}^{TX}<n_{RX}^{src}+O_{TX,2}^{src}−1, or satisfies n_{CO,first}^{TX}≤n_{RX}^{src}+O_{TX,2}^{src}+1, or satisfies n_{CO,first}^{TX}<n_{RX}^{src}+O_{TX,2}^{src}+1.

Optionally, a slot (e.g., denoted as a slot n_{CO,last}^{TX}) where the last PSCCH and/or PSSCH transmission corresponding to the inter-UE coordination message is located satisfies n_{CO,last}^{TX}≤n_{RX}^{src}+O_{TX,2}^{src}, or satisfies n_{CO,last}^{TX}<n_{RX}^{src}+O_{TX,2}^{src}, or satisfies n_{CO,last}^{TX}≤n_{RX}^{src}+O_{TX,2}^{src}−1, or satisfies n_{CO,last}^{TX}<n_{RX}^{src}+O_{TX,2}^{src}−1, or satisfies n_{CO,last}^{TX}≤n_{RX}^{src}+O_{TX,2}^{src}+1, or satisfies n_{CO,last}^{TX}<n_{RX}^{src}+O_{TX,2}^{src}+1.

Optionally, a coordination resource set (e.g., denoted as E_{CO}) is indicated in the inter-UE coordination message. Optionally, the coordination resource set E_{CO} includes one or more coordination resources (e.g., respectively denoted as e₁^{co,E}, e₂^{co,E}, . . . , and e_{N}_{_{RES}}_{^{co,E}}^{co,E} wherein N_{RES}^{co,E} is the number of coordination resources in the coordination resource set E_{CO}). Optionally, all coordination resources in the coordination resource set E_{CO} belong to the coordination resource pool u_{CO}^{src}.

Optionally, a coordination resource set priority (e.g., denoted as p_{CO}^{E}) of the coordination resource set E_{CO} is indicated in the inter-UE coordination message.

Optionally, the “coordination resource priority” of one or more coordination resources in the coordination resource set E_{CO} is indicated in the inter-UE coordination message. The coordination resource priority corresponding to (or associated with) the coordination resource eₖ^{co,E} (1≤k≤n_{RES}^{co,E}) may be denoted as pₖ^{co,E}. Optionally, if the coordination resource priority pₖ^{co,E} (1≤k≤N_{RES}^{co,E}) is not indicated in the inter-UE coordination message, then it is indicated that the coordination resource priority pₖ^{co,E} corresponds to a predefined value, or a value configured by means of a higher layer protocol, or a value pre-configured by means of a higher layer protocol.

Optionally, in all coordination resources in the coordination resource set E_{CO}, the slot where the earliest coordination resource is located (or the first slot of the earliest coordination resource) is not earlier than (or is later than) a coordination resource window starting slot (e.g., denoted as n_{CO,start}^{abs,0}). The coordination resource window starting slot n_{CO,start}^{abs,0} may be one of the following:
The coordination starting slot n_{CO,start}^{src,abs}.
A slot preceding the coordination starting slot n_{CO,start}^{src,abs} in the slot set of the coordination resource pool u_{CO}^{src}.
A slot following the coordination starting slot n_{CO,start}^{src,abs} in the slot set of the coordination resource pool u_{CO}^{src}.
A slot preceding the coordination starting slot n_{CO,start}^{src,abs} in a set (i.e., {0, 1, . . . , 10240×2^{μ}^{_{SL}}−1}) of all slots in an SFN period (or a DFN period).
A slot following the coordination starting slot n_{CO,start}^{src,abs} in a set (i.e., {0, 1, . . . , 10240×2^{μ}^{_{SL}}−1}) of all slots in an SFN period (or a DFN period).

Optionally, in all coordination resources in the coordination resource set E_{CO}, the slot where the latest coordination resource is located (or the last slot of the latest coordination resource) is not later than (or is earlier than) a coordination resource window ending slot (e.g., denoted as n_{CO,end}^{abs,0}). The coordination resource window ending slot n_{CO,end}^{abs,0} may be one of the following:
The w_{CO}^{src}-th slot that is in the slot set of the coordination resource pool u_{CO}^{src} and that is counted starting from the coordination resource window starting slot n_{CO,start}^{abs,0} (including the coordination resource window starting slot n_{CO,start}^{abs,0} or not including the coordination resource window starting slot n_{CO,start}^{abs,0}).
The w_{CO}^{src}+1-th slot that is in the slot set of the coordination resource pool u_{CO}^{src} and that is counted starting from the coordination resource window starting slot n_{CO,start}^{abs,0} (including the coordination resource window starting slot n_{CO,start}^{abs,0} or not including the coordination resource window starting slot n_{CO,start}^{abs,0}).
The w_{CO}^{src}−1-th slot that is in the slot set of the coordination resource pool u_{CO}^{src} and that is counted starting from the coordination resource window starting slot n_{CO,start}^{abs,0} (including the coordination resource window starting slot n_{CO,start}^{abs,0} or not including the coordination resource window starting slot n_{CO,start}^{abs,0}).
The w_{CO}^{src}-th slot that is in the slot set of the coordination resource pool u_{CO}^{src} and that is counted starting from the coordination starting slot n_{CO,start}^{src,abs} (including the coordination starting slot n_{CO,start}^{src,abs} or not including the coordination starting slot n_{CO,start}^{src,abs}).
The w_{CO}^{src}+1-th slot that is in the slot set of the coordination resource pool u_{CO}^{src} and that is counted starting from the coordination starting slot n_{CO,start}^{src,abs} (including the coordination starting slot n_{CO,start}^{src,abs} or not including the coordination starting slot n_{CO,start}^{src,abs}).
The w_{CO}^{src}−1-th slot that is in the slot set of the coordination resource pool u_{CO}^{src} and that is counted starting from the coordination starting slot n_{CO,start}^{src,abs} (including the coordination starting slot n_{CO,start}^{src,abs} or not including the coordination starting slot n_{CO,start}^{src,abs}).
The coordination ending slot n_{CO,end}^{src,abs}.
A slot preceding the coordination ending slot n_{CO,end}^{src,abs} in the slot set of the coordination resource pool u_{CO}^{src}.
A slot following the coordination ending slot n_{CO,end}^{src,abs} in the slot set of the coordination resource pool u_{CO}^{src}.
A slot preceding the coordination ending slot n_{CO,end}^{src,abs} in a set (i.e., {0, 1, . . . , 10240×2^{μ}^{_{SL}}−1}) of all slots in an SFN period (or a DFN period).
A slot following the coordination ending slot n_{CO,end}^{src,abs} in a set (i.e., {0, 1, . . . , 10240×2^{μ}^{_{SL}}−1}) of all slots in an SFN period (or a DFN period).

Optionally, all slots (including the coordination resource window starting slot n_{CO,start}^{abs,0} and/or the coordination resource window ending slot n_{CO,end}^{abs,0}, or not including the coordination resource window starting slot n_{CO,start}^{abs,0} and/or the coordination resource window ending slot n_{CO,end}^{abs,0}) between the coordination resource window starting slot n_{CO,start}^{abs,0} and the coordination resource window ending slot n_{CO,end}^{abs,0} correspond to a “coordination resource window”.

Optionally, all coordination resources of the coordination resource set E_{CO} are in a reference resource grid (e.g., denoted as D_{co}, a corresponding reference resource grid starting slot being denoted as t_{CO,0}^{D}, a reference resource grid time domain length being denoted as W_{CO}^{D}, a reference resource grid starting sub-channel being denoted as c_{CO,0}^{D}, and a reference resource grid frequency domain length being denoted as V_{CO}^{D}). wherein
Optionally, the reference resource grid D_{co} corresponds to (or is associated with) the coordination resource pool u_{CO}^{src}.
Optionally, the reference resource grid starting slot t_{CO,0}^{D} is determined according to the coordination starting slot n_{CO,start}^{src,abs}, for example, t_{CO,0}^{D}=n_{CO,start}^{src,abs}.
Optionally, the reference resource grid starting slot t_{CO,0}^{D} is determined according to the slot n_{CO,start}^{abs,0}, for example, t_{CO,0}^{D}=n_{CO,start}^{abs,0}.
Optionally, the reference resource grid time domain length W_{CO}^{D} is determined according to the coordination resource window length w_{CO}^{src}, for example, W_{CO}^{D}=w_{CO}^{src}.
Optionally, the reference resource grid starting sub-channel c_{CO,0}^{D} is determined according to the coordination starting frequency c_{CO,start}^{src}, for example, c_{CO,0}^{D}=c_{CO,start}^{src}.
Optionally, the reference resource grid frequency domain length V_{CO}^{D} is determined according to the coordination bandwidth v_{CO}^{src}, for example, V_{CO}^{D}=v_{CO}^{src}.

Optionally, the number (e.g., denoted as N_{CO}^{D}) of reference resources in the reference resource grid D_{co} may be determined according to one of the following:

$${N}_{CO}^{D} = \frac{{W}_{CO}^{D}}{{T}_{ref}^{src}} \cdot \frac{{V}_{CO}^{D}}{{F}_{ref}^{src}} . \\ {N}_{CO}^{D} = ⌊ \frac{{W}_{CO}^{D}}{{T}_{ref}^{src}} \cdot \frac{{V}_{CO}^{D}}{{F}_{ref}^{src}} ⌋ . \\ {N}_{CO}^{D} = ⌊ \frac{{W}_{CO}^{D}}{{T}_{ref}^{src}} ⌋ \cdot ⌊ \frac{{V}_{CO}^{D}}{{F}_{ref}^{src}} ⌋ . \\ {N}_{CO}^{D} = ⌈ \frac{{W}_{CO}^{D}}{{T}_{ref}^{src}} ⌉ \cdot ⌈ \frac{{V}_{CO}^{D}}{{F}_{ref}^{src}} ⌉ . \\ {N}_{CO}^{D} = ⌈ \frac{{W}_{CO}^{D}}{{T}_{ref}^{src}} \cdot \frac{{V}_{CO}^{D}}{{F}_{ref}^{src}} ⌉ . \\ {N}_{CO}^{D} = ⌊ \frac{{W}_{CO}^{D}}{{T}_{ref}^{src}} ⌋ \cdot ⌈ \frac{{V}_{CO}^{D}}{{F}_{ref}^{src}} ⌉ . \\ {N}_{CO}^{D} = ⌈ \frac{{W}_{CO}^{D}}{{T}_{ref}^{src}} ⌉ \cdot ⌊ \frac{{V}_{CO}^{D}}{{F}_{ref}^{src}} ⌋ .$$

Correspondingly, reference resource numbers of the reference resource grid D_{co} may sequentially be {0, 1, . . . , N_{CO}^{D}−1}, or sequentially be {1, 2, . . . , N_{CO}^{D}}.

Optionally, a coordination resource in the coordination resource set E_{CO} is determined according to one or more SCIs (e.g., one or more SCIs detected in “sensing” and/or other operations related to inter-UE coordination).

For example, if one (or more) resources respectively indicated (or reserved or assigned, e.g., indicated, reserved, or assigned by means of a “frequency resource assignment” field and/or a “time resource assignment” field and/or a “resource reservation period” field) by N_{CO}^{SCI,DET} SCIs (e.g., respectively denoted as SCI₁^{DET}, SCI₂^{DET}, . . . , SCI_{N}_{_{CO}}_{^{SCI,DET}}^{DET}) overlap the coordination resource window (e.g., overlapping in any sub-channel), then part or all of the overlapping resources are determined as the coordination resource. SCI_{N}_{_{CO}}_{^{SCI,DET}}^{DET} may be an integer, e.g., a predefined integer, an integer configured by means of a higher layer protocol, or an integer pre-configured by means of a higher layer protocol, or any integer greater than N_{CO,MAX}^{SCI,DET}, or any integer greater than or equal to N_{CO,MAX}^{SCI,DET}, or any integer equal to N_{CO,MAX}^{SCI,DET}, or any integer less than or equal to N_{CO,MAX}^{SCI,DET} or any integer less than N_{CO,MAX}^{SCI,DET}, or any positive integer. N_{CO,MAX}^{SCI,DET} may be a predefined integer (e.g., N_{CO,MAX}^{SCI,DET}=1, or N_{CO,MAX}^{SCI,DET}=2, or N_{CO,MAX}^{SCI,DET}=3), or an integer configured by means of a higher layer protocol, or an integer pre-configured by means of a higher layer protocol.

As another example, if one (or more) resources respectively indicated (or reserved, or allocated) by the N_{CO}^{SCI,DET} SCIs (SCI₁^{DET}, SCI₂^{DET}, . . . , SCI_{N}_{_{CO}}_{^{SCI,DET}}^{DET}) overlap on the reference resource n (0≤n≤N_{CO}^{D}−1) in the reference resource grid D_{co}, the reference resource n is determined as a coordination resource (e.g., the reference resource n is added to the coordination resource set E_{CO}, and e.g., the reference resource n corresponds to the coordination resource eₖ_{₀}^{co,E} in the coordination resource set E_{CO}, wherein 1≤k₀≤N_{RES}^{co,E}). Specifically, for example, if the resource set (e.g., respectively denoted as R₁^{SCI,DET}, R₂^{SCI,DET}, . . . , and R_{N}_{_{co}}_{^{SCI,DET}}^{SCI,DET}) indicated (or reserved, or allocated) by the N_{CO}^{SCI,DET} SCIs (SCI₁^{DET}, SCI₂^{DET}, . . . , SCI_{N}_{_{co}}_{^{SCI,DET}}^{DET}) and the reference resource n satisfy a first coordination resource condition, then the reference resource n is determined as the coordination resource eₖ_{₀}^{co,E}. In addition, optionally, the “coordination resource priority” pₖ_{₀}^{co,E} of the coordination resource eₖ_{₀}^{co,E} is determined according to priority values (e.g., respectively denoted as p₁^{SCI,DET}, p₂^{SCI,DET}, . . . , p_{N}_{_{co}}_{^{SCI,DET}}^{SCI,DET}) indicated by the N_{CO}^{SCI,DET} SCIs (SCI₁^{DET}, SCI₂^{DET}, . . . , SCI_{N}_{_{CO}}_{^{SCI,DET}}^{DET}).

Optionally, the first coordination resource condition may include one or more of the following (in any combination of “and” or “or” when applicable):
A resource corresponding to R₁^{SCI}, a resource corresponding to R₂^{SCI}, . . . , and a resource corresponding to R_{N}_{_{SCI}}_{^{sensing}}^{SCI} overlap on the reference resource n.
Part of a resource corresponding to R₁^{SCI}, part of a resource corresponding to R₂^{SCI}, . . . , and part of a resource corresponding to R_{N}_{_{SCI}}_{^{sensing}}^{SCI} overlap on the reference resource n.
Part or all of a resource corresponding to R₁^{SCI}, part or all of a resource corresponding to R₂^{SCI}, . . . , and part or all of a resource corresponding to R_{N}_{_{SCI}}_{^{sensing}}^{SCI} overlap on the reference resource n.
A resource corresponding to R₁^{SCI}, a resource corresponding to R₂^{SCI}, . . . , and a resource corresponding to R_{N}_{_{SCI}}_{^{sensing}}^{SCI} all include part or all of the reference resource n.
Part of a resource corresponding to R₁^{SCI}, part of a resource corresponding to R₂^{SCI}, . . . , and part of a resource corresponding to R_{N}_{_{SCI}}_{^{sensing}}^{SCI} all include part or all of the reference resource n.
Part or all of a resource corresponding to R₁^{SCI}, part or all of a resource corresponding to R₂^{SCI}, . . . , and part or all of a resource corresponding to R_{N}_{_{SCI}}_{^{sensing}}^{SCI} all include part or all of the reference resource n.
A resource corresponding to R₁^{SCI}, a resource corresponding to R₂^{SCI}, . . . , and a resource corresponding to R_{N}_{_{SCI}}_{^{sensing}}^{SCI} are all equal to the reference resource n.
Part of a resource corresponding to R₁^{SCI}, part of a resource corresponding to R₂^{SCI}, . . . , and part of a resource corresponding to R_{N}_{_{SCI}}_{^{sensing}}^{SCI} are all equal to the reference resource n.
Part or all of a resource corresponding to R₁^{SCI}, part or all of a resource corresponding to R₂^{SCI}, . . . , and part or all of a resource corresponding to R_{N}_{_{SCI}}_{^{sensing}}^{SCI} are all equal to the reference resource n.

Optionally, “part of a resource corresponding to Rᵢ^{SCI}” (1≤i≤N_{SCI}^{sensing}) may refer to one or more resources in Rᵢ^{SCI}, or part of a resource in Rᵢ^{SCI}, or a union set of part of each one of a plurality of resources in Rᵢ^{SCI}. Optionally, if both a and b include part of the reference resource n, the part of the reference resource n included in a may be different from the part of the reference resource n included in b. Optionally, the “part” may be part of time-frequency resources defined in any manner, such as one or more sub-channels in one or more slots.

Optionally, the “coordination resource priority” pₖ_{₀}^{co,E} may be determined according to the priority value p₁^{SCI,DET}, p₂^{SCI,DET}, . . . , p_{N}_{_{co}}_{^{SCI,DET}}^{SCI,DET} in one of the following manners:
pₖ_{₀}^{co,E}=min(p₁^{SCI,DET}, p₂^{SCI,DET}, . . . , p_{N}_{_{co}}_{^{SCI,DET}}^{SCI,DET}).
pₖ_{₀}^{co,E}=min(p₁^{SCI,DET}−1, p₂^{SCI,DET}−1, . . . , p_{N}_{_{co}}_{^{SCI,DET}}^{SCI,DET}−1).
pₖ_{₀}^{co,E}=min(p₁^{SCI,DET}+1, p₂^{SCI,DET}+1, . . . , p_{N}_{_{co}}_{^{SCI,DET}}^{SCI,DET}+1).
pₖ_{₀}^{co,E}=max(p₁^{SCI,DET}, p₂^{SCI,DET}, . . . , p_{N}_{_{co}}_{^{SCI,DET}}^{SCI,DET}).
pₖ_{₀}^{co,E}=max(p₁^{SCI,DET}−1, p₂^{SCI,DET}−1, . . . p_{N}_{_{co}}_{^{SCI,DET}}^{SCI,DET}−1).
pₖ_{₀}^{co,E}=max(p₁^{SCI,DET}+1, p₂^{SCI,DET}+1, . . . , p_{N}_{_{co}}_{^{SCI,DET}}^{SCI,DET}+1).

Optionally, a “tie” flag for one or more coordination resources in the coordination resource set E_{CO} is indicated in the inter-UE coordination message. For example, if for the coordination resource eₖ_{₀}^{co,E}, two or more of the priority values p₁^{SCI,DET}, p₂^{SCI,DET}, . . . , p_{N}_{_{co}}_{^{SCI,DET}}^{SCI,DET} correspond to the highest priority (e.g., the corresponding priority value is 0, or the corresponding priority value is 1), a “tie” flag is indicated for the coordination resource eₖ_{₀}^{co,E}.

In addition, optionally, in step S105, the inter-UE coordination message is transmitted. For example, the inter-UE coordination message is transmitted in a slot t_{TX} in a resource pool u_{TX}.

Optionally, in Embodiment 1 of the present invention, reference resource numbers of the reference resource grid D_{co} may sequentially be {1, 2, . . . , N_{CO}^{D}}, and correspondingly, the value range of the reference resource n is [1, N_{CO}^{D}].

Optionally, in Embodiment 1 of the present invention, “overlapping on the reference resource n” may refer to overlapping on part of the reference resource n, or overlapping on the entirety of the reference resource n, specifically such as one of the following:
Overlapping on at least one sub-channel in at least one slot of the reference resource n.
Overlapping on all sub-channels in at least one slot of the reference resource n.
Overlapping on one or more sub-channels in one or more slots of the reference resource n.
Overlapping on all sub-channels in one or more slots of the reference resource n.
Overlapping on at least one sub-channel in all slots of the reference resource n.
Overlapping on one or more sub-channels in all slots of the reference resource n.
Overlapping on all sub-channels in all slots of the reference resource n.
Overlapping in at least one slot of the reference resource n.
Overlapping in one or more slots of the reference resource n.
Overlapping in all slots of the reference resource n.
Overlapping on at least one sub-channel of the reference resource n.
Overlapping on one or more sub-channels of the reference resource n.
Overlapping on all sub-channels of the reference resource n.
Overlapping on any part of the reference resource n.
Fully overlapping on the reference resource n.
Overlapping on any RE of the reference resource n.
Overlapping on one or more REs of the reference resource n.
Overlapping on all REs of the reference resource n.

Optionally, in Embodiment 1 of the present invention, the time unit involved in “overlapping on the reference resource n” may be changed from “slots” to OFDM symbols, or subframes, or half-frames, or frames, or milliseconds, or seconds, or other time units.

Optionally, in Embodiment 1 of the present invention, the frequency unit involved in “overlapping on the reference resource n” may be changed from “sub-channels” to resource blocks, or resource block groups, or subcarriers, or hertz, or kilohertz, or megahertz, or other frequency units.

Optionally, in Embodiment 1 of the present invention, the number of reference resource grids corresponding to the coordination resource pool u_{CO}^{src} may be greater than 1. For example, the coordination resource pool u_{CO}^{src} may correspond to N_{CO}^{GRID} reference resource grids (e.g., respectively denoted as D_{CO,1}, D_{CO,2}, . . . , D_{CO,N}_{_{CO}}_{^{GRID}}). Optionally, N_{CO}^{GRID} may be a predefined value (e.g., N_{CO}^{GRID}=1, or N_{CO}^{GRID}=2, or N_{CO}^{GRID}=3), or a value configured by means of a higher layer protocol, or a value pre-configured by means of a higher layer protocol, or is indicated by the inter-UE coordination request message, or is determined according to indication information in the inter-UE coordination request message. Optionally, all coordination resources of the coordination resource set E_{CO} are in the reference resource grid D_{CO,a} (1≤a≤N_{CO}^{GRID}), wherein a may be a predefined value, or a value configured by means of a higher layer protocol, or a value pre-configured by means of a higher layer protocol, or is indicated in the inter-UE coordination request message, or is determined according to indication information in the inter-UE coordination request message.

Optionally, in Embodiment 1 of the present invention, the number of coordination resource sets indicated in the inter-UE coordination message may be greater than 1. For example, the inter-UE coordination message may indicate N_{CO}^{RESSET} coordination resource sets (e.g., respectively denoted as E_{CO,1}, E_{CO,2}, . . . , E_{CO,N}_{_{CO}}_{^{RESSET}}). Optionally, N_{CO}^{RESSET} may be a predefined value (e.g., N_{CO}^{RESSET}=1, or N_{CO}^{RESSET}=2, or N_{CO}^{RESSET}=3), or a value configured by means of a higher layer protocol, or a value pre-configured by means of a higher layer protocol, or is indicated by the inter-UE coordination request message, or is determined according to indication information in the inter-UE coordination request message. Optionally, the coordination resource set priority corresponding to (or associated with) the coordination resource set E_{CO,i} (1≤i≤N_{RESSET}^{co}) may be denoted as pᵢ^{CO,E}. Optionally, the coordination resource set E_{CO,i} (1≤i≤N_{CO}^{RESSET}) may be denoted as E_{CO,i}={e_{i,1}^{CO,E}, e_{i,2}^{CO,E}, . . . , e_{i,N}_{_{RES,i}}_{^{CO,E}}^{CO,E}}, where n_{RES,i}^{CO,E} is the number of coordination resources in the set E_{CO, i} and e_{i,j}^{CO,E} (1≤j≤N_{RES,i}^{CO,E}) is the j-th coordination resource in the set E_{CO,i}. Optionally, the coordination resource priority corresponding to (or associated with) the coordination resource e_{i,j}^{CO,E} may be denoted as p_{i,j}^{CO,E}. Correspondingly, for each coordination resource set E_{CO,i} (1≤i≤N_{CO}^{RESSET}), one or more of the following may be respectively determined (values respectively determined for any one of the following may be the same or different for i≠j , the coordination resource set E_{CO,i} and the coordination resource set E_{CO,j}):
Coordination resource set type Y_{CO}^{src}.
Coordination resource pool u_{CO}^{src}.
Time domain size T_{ref}^{src} of each reference resource.
Frequency domain size F_{ref}^{src} of each reference resource.
Coordination starting frequency c_{CO,start}^{src}.
Coordination bandwidth v_{CO}^{src}.
Coordination starting slot n_{CO,start}^{src,abs}.
Coordination starting slot offset O_{CO,start}^{src,rel}.
First starting slot n_{start,1}^{src}.
Second starting slot n_{start,2}^{src}.
Coordination ending slot n_{CO,end}^{src,abs}.
Coordination ending slot offset O_{CO,end}^{src,rel}.
First ending slot n_{end,1}^{src}.
Second ending slot n_{end,2}^{src}.
Coordination resource window length w_{CO}^{src}.
Coordination resource window starting slot n_{CO,start}^{abs,0}.
Coordination resource window ending slot n_{CO,end}^{abs,0}.
Reference resource grid D_{co}.
Coordination resource set priority pᵢ^{CO,E}.

Thus, according to Embodiment 1, provided in the present invention is a method, in which a priority of a coordination resource is indicated in an inter-UE coordination message, so that a plurality of UEs receiving the inter-UE coordination message may determine, according to a priority indicated when a resource corresponding to the coordination resource (e.g., a resource coinciding with the coordination resource) was allocated and/or reserved thereby, whether to drop the coordination resource, thereby alleviating the problem of resource conflict in a distributed resource reservation mechanism, and improving resource utilization efficiency.

### Embodiment 2

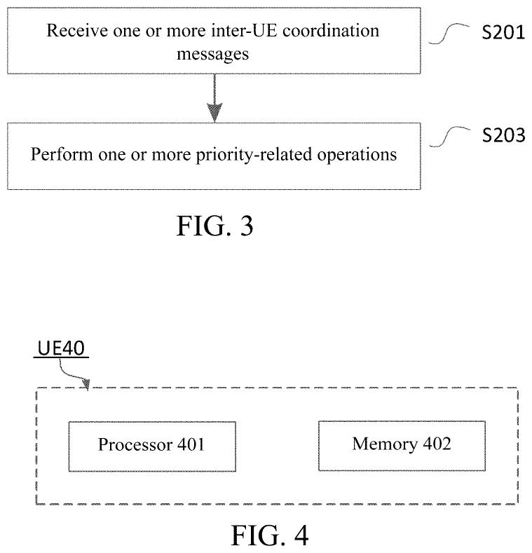

A method performed by user equipment according to Embodiment 2 of the present invention will be described below with reference to FIG. 3.

FIG. 3 is a flowchart showing a method performed by user equipment according to Embodiment 2 of the present invention.

As shown in FIG. 3, in Embodiment 2 of the present invention, steps performed by the user equipment (UE) include: step S201 and step S203.

Specifically, in step S201, one or more inter-UE coordination messages (e.g., respectively denoted as MSG_{CO,1}^{RX}, MSG_{CO,2}^{RX}, . . . , MSG_{CO,N}_{_{CO}}_{^{MSG,RX}}^{RX}, wherein N_{CO}^{MSG,RX} is the number of received inter-UE coordination messages) are received.

Optionally, each of the inter-UE coordination messages MSG_{CO,1}^{RX}, MSG_{CO,2}^{RX}, . . . , MSG_{CO,N}_{_{CO}}_{^{MSG,RX}}^{Rx} may be determined and/or transmitted according to the steps in Embodiment 1 of the present invention.

Furthermore, in step S203, one or more priority-related operations are performed.

Optionally, if a first priority condition is satisfied, a first priority operation is performed.

Optionally, the first priority condition may be any one or more of the following (in any combination of “and” or “or” when applicable):
“Coordination resource set types” respectively indicated by the inter-UE coordination messages MSG_{CO,1}^{RX}, MSG_{CO,2}^{RX}, . . . , MSG_{CO,N}_{_{CO}}_{^{MSG,RX}}^{RX} are “a set of non-preferred resources”, or “a set of resources having a detected conflict”, or “a set of resources having a potential conflict”, or “a set of resources expected to have a conflict”.
In all coordination resources indicated by the inter-UE coordination message MSG_{CO,1}^{RX}, MSG_{CO,2}^{RX}, . . . , MSG_{CO,N}_{_{CO}}_{^{MSG,RX}}^{RX}, if a coordination resource (e.g., corresponding to a reference resource n₀^{RX}, a corresponding coordination resource priority value being p₀^{RX}) overlaps with an allocated or reserved (e.g., allocated or reserved by transmitting SCI) resource (e.g., denoted as e₀^{RES}, and a corresponding priority value indicated in the SCI being p₀^{RES}) of the UE, and the coordination resource priority of the coordination resource n₀^{RX} is higher than the priority of the allocated or reserved resource (e.g., p₀^{RX}<p₀^{RES} (e.g., when the priority decreases as the priority value increases), or p₀^{RX}>p₀^{RES} (e.g., when the priority increases as the priority value increases)).
In all coordination resources indicated by the inter-UE coordination message MSG_{CO,1}^{RX}, MSG_{CO,2}^{RX}, . . . , MSG_{CO,N}_{_{CO}}_{^{MSG,RX}}^{RX}, if at least one coordination resource (e.g., corresponding to a reference resource n₀^{RX}, a corresponding coordination resource priority value being p₀^{RX}) overlaps with an allocated or reserved (e.g., allocated or reserved by transmitting SCI) resource (e.g., denoted as e₀^{RES}, and a corresponding priority value indicated in the SCI being p₀^{RES}) of the UE, and the coordination resource priority of the coordination resource n₀^{RX} is higher than the priority of the allocated or reserved resource (e.g., p₀^{RX}<p₀^{RES} (e.g., when the priority decreases as the priority value increases), or p₀^{RX}>p₀^{RES} (e.g., when the priority increases as the priority value increases)).

Optionally, the first priority operation includes one or more of the following:
Removing the resource e₀^{RES} rom a corresponding sidelink (SL) grant.
Performing resource re-selection for the resource e₀^{RES}, for example, selecting a resource (for example, randomly selecting a resource not overlapping with the resource e₀^{RES}) from a set of “available resources” determined by the physical layer by means of a resource selection mechanism.

Thus, according to Embodiment 2, provided in the present invention is a method, in which a priority of a coordination resource is indicated in an inter-UE coordination message, so that a plurality of UEs receiving the inter-UE coordination message may determine, according to a priority indicated when a resource corresponding to the coordination resource (e.g., a resource coinciding with the coordination resource) was allocated and/or reserved thereby, whether to drop the coordination resource, thereby alleviating the problem of resource conflict in a distributed resource reservation mechanism, and improving resource utilization efficiency.

### Variant Embodiment

Hereinafter, FIG. 4 is used to illustrate user equipment that can perform the method performed by user equipment described in detail above in the present invention as a variant embodiment.

FIG. 4 shows a block diagram of user equipment (UE) according to the present invention.

As shown in FIG. 4, the user equipment (UE) 40 includes a processor 401 and a memory 402. The processor 401 may include, for example, a microprocessor, a microcontroller, an embedded processor, and the like. The memory 402 may include, for example, a volatile memory (such as a random access memory (RAM)), a hard disk drive (HDD), a non-volatile memory (such as a flash memory), or other memories. The memory 402 stores program instructions. The instructions, when run by the processor 401, can implement the above method performed by user equipment as described in detail in the present invention.

The method and related equipment according to the present invention have been described above in combination with preferred embodiments. It should be understood by those skilled in the art that the method shown above is only exemplary, and the above embodiments can be combined with one another as long as no contradiction arises. The method of the present invention is not limited to the steps or sequences illustrated above. The network node and user equipment illustrated above may include more modules. For example, the network node and user equipment may further include modules that can be developed or will be developed in the future to be applied to a base station, an AMF, a UPF, an MME, an S-GW, or UE, and the like. Various identifiers shown above are only exemplary, and are not meant for limiting the present invention. The present invention is not limited to specific information elements serving as examples of these identifiers. A person skilled in the art could make various alterations and modifications according to the teachings of the illustrated embodiments. Those skilled in the art should understand that part or all of the mathematical expressions, mathematical equations, or mathematical inequalities may be simplified or transformed or rewritten to some extent, for example, incorporating constant terms, or interchanging two addition terms, or interchanging two multiplication terms, or moving a term from the left side of an equation or inequality to the right side after changing the plus or minus sign thereof, or moving a term from the right side of an equation or inequality to the left side after changing the plus or minus sign thereof or the like. Mathematical expressions, mathematical equations, or mathematical inequalities before and after the simplification or transformation or rewriting may be considered to be equivalent to each other. Those skilled in the art would appreciate that a subset of a set may be the set itself. For example, a subset of A={a₁, a₂} may be {a₁, a₂}, or {a₁}, or {a₂}, or an empty set.

It should be understood that the above-described embodiments of the present invention may be implemented by software, hardware, or a combination of software and hardware. For example, various components of the base station and user equipment in the above embodiments can be implemented by multiple devices, and these devices include, but are not limited to: an analog circuit device, a digital circuit device, a digital signal processing (DSP) circuit, a programmable processor, an application specific integrated circuit (ASIC), a field programmable gate array (FPGA), and a complex programmable logic device (CPLD), and the like.

In the present invention, the term “base station” may refer to a mobile communication data and/or control switching center having specific transmission power and a specific coverage area and including functions such as resource allocation and scheduling, data reception and transmission, and the like. “User equipment” may refer to a user mobile terminal, for example, including terminal devices that can communicate with a base station or a micro base station wirelessly, such as a mobile phone, a laptop computer, and the like.

In addition, the embodiments of the present invention disclosed herein may be implemented on a computer program product. More specifically, the computer program product is a product provided with a computer-readable medium having computer program logic encoded thereon. When executed on a computing device, the computer program logic provides related operations to implement the above technical solutions of the present invention. When executed on at least one processor of a computing system, the computer program logic causes the processor to perform the operations (the method) described in the embodiments of the present invention. Such setting of the present invention is typically provided as software, codes and/or other data structures provided or encoded on the computer readable medium, e.g., an optical medium (e.g., compact disc read-only memory (CD-ROM)), a flexible disk or a hard disk and the like, or other media such as firmware or micro codes on one or more read-only memory (ROM) or random access memory (RAM) or programmable read-only memory (PROM) chips, or a downloadable software image, a shared database and the like in one or more modules. Software or firmware or such configuration may be installed on a computing device such that one or more processors in the computing device perform the technical solutions described in the embodiments of the present invention.

In addition, each functional module or each feature of the base station device and the terminal device used in each of the above embodiments may be implemented or executed by a circuit, which is usually one or more integrated circuits. Circuits designed to execute various functions described in this description may include general-purpose processors, digital signal processors (DSPs), application specific integrated circuits (ASICs) or general-purpose integrated circuits, field programmable gate arrays (FPGAs) or other programmable logic devices, discrete gates or transistor logic, or discrete hardware components, or any combination of the above. The general purpose processor may be a microprocessor, or the processor may be an existing processor, a controller, a microcontroller, or a state machine. The aforementioned general purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1. A method performed by user equipment (UE), the method comprising:
receiving an Inter-UE Coordination (IUC) request, wherein,
the IUC request is carried in second-stage SCI or in a MAC CE,
the IUC request indicates a priority, and
the IUC request indicates a resource set type as “preferred resource set” or “non-preferred resource set”; and
transmitting an IUC response in response to the IUC request, wherein
the IUC response is carried in second-stage SCI or in a MAC CE,
the IUC response indicates a resource set,
the IUC response indicates a corresponding resource set type as “preferred resource set” or “non-preferred resource set”,
a priority of transmitting the IUC response is determined based on the priority indicated by the IUC request, and
the corresponding resource set type is determined based on the resource set type indicated by the IUC request.

2. User equipment, comprising:
a processor; and a memory, storing instructions,
wherein the instructions, when run by the processor, cause the user equipment to:
receive an Inter-UE Coordination (IUC) request, wherein,
the IUC request is carried in second-stage SCI or in a MAC CE,
the IUC request indicates a priority, and
the IUC request indicates a resource set type as “preferred resource set” or “non-preferred resource set”; and
transmit an IUC response in response to the IUC request, wherein
the IUC response is carried in second-stage SCI or in a MAC CE,
the IUC response indicates a resource set,
the IUC response indicates a corresponding resource set type as “preferred resource set” or “non-preferred resource set”,
a priority of transmitting the IUC response is determined based on the priority indicated by the IUC request, and
the corresponding resource set type is determined based on the resource set type indicated by the IUC request.

3. User equipment, comprising:
a processor; and a memory, storing instructions,
wherein the instructions, when run by the processor, cause the user equipment to:
transmit an Inter-UE Coordination (IUC) request, wherein,
the IUC request is carried in second-stage SCI or in a MAC CE,
the IUC request indicates a priority, and
the IUC request indicates a resource set type as “preferred resource set” or “non-preferred resource set”; and
receive an IUC response corresponding to the IUC request, wherein
the IUC response is carried in second-stage SCI or in a MAC CE,
the IUC response indicates a resource set,
the IUC response indicates a corresponding resource set type as “preferred resource set” or “non-preferred resource set”, and
the IUC response is received in accordance with a priority determined based on the priority indicated by the IUC request, and
the corresponding resource set type is determined based on the resource set type indicated by the IUC request.
